(19) United States
(12) Patent Application Publication
(10) Pub. No.: US 2022/0082268 A1
(43) Pub. Date: Mar. 17, 2022

(54) VARIABLE CAPACITY HEAT PUMP SYSTEM

(71) Applicant: WaterFurnace International, Inc., Fort Wayne, IN (US)

(72) Inventors: Timothy A. Hammond, Harlan, IN (US); Dennis L. Harris, Harmony, FL (US); Robert R. Brown, Markle, IN (US)

(21) Appl. No.: 17/472,216

(22) Filed: Sep. 10, 2021

Related U.S. Application Data
(60) Provisional application No. 63/076,991, filed on Sep. 11, 2020.

(51) Int. Cl. F24D 5/12; F24D 11/02; F24D 19/10

(52) U.S. Cl. CPC F24D 5/12; F24D 5/04; F24D 19/1087; F24D 11/0285

(57) ABSTRACT

A heat pump system includes a compressor coupled to a first variable speed motor, a first heat exchanger, a geothermal heat exchanger, a fan coupled to a second variable speed motor, and an expansion device. The heat pump system also includes a refrigerant loop which fluidly couples the compressor, the geothermal heat exchanger, the expansion device, and the first heat exchanger. The heat pump system also includes a controller configured to adjust a first speed of the first variable speed motor, a second speed of the second variable speed motor, and an operation of the expansion device based upon a thermal energy demand.

### CROSS-REFERENCE TO RELATED APPLICATION

This application claims priority to U.S. Provisional Application No. 63/076,991, filed Sep. 11, 2020, the entirety of this reference incorporated herein.

### BACKGROUND

### 1. Technical Field

The present disclosure relates to heat pump systems that are used to provide heating and cooling to an interior space of a building and, in particular, the present disclosure relates to a modular, variable capacity heat pump system.

### 2. Description of the Related Art

Geothermal heat pump systems utilize the earth as a heat source or heat sink for interior heating and cooling. Traditionally, a large capacity water-cooled HVAC system is installed in a building on a given floor at the time of construction. These single unit systems often utilize a standard fixed-speed compressor and refrigerant loop, where conditioned air is supplied to the building's HVAC ducting via a fixed speed fan.

When it is time to replace this equipment, there is a significant amount of labor required to disassemble the HVAC system in order to remove it from the building. HVAC retrofit solutions for this type of system is to have a single unit that is taken apart on the jobsite and then re-assembled inside the mechanical room. This is sometimes referred to as modular self-contained replacement equipment. This solution may allow for replacement of the equipment yet is labor intensive and still considered a single piece of equipment after re-assembly. If this equipment breaks (e.g., a leaky air coil or failed compressor), the entire system may need to be shut down. Furthermore, this is costly and leaves the building and the buildings residents without HVAC for the duration of the equipment replacement operation.

What is needed is an improvement over the foregoing.

### SUMMARY

The present disclosure provides a geothermal heat pump system which may be installed in a building that includes variable speed components (e.g., a variable speed fan and a variable speed compressor) which enables the heat pump system to operate at a variety of thermal outputs (e.g., the heat pump system has a variable capacity). In some cases, the heat pump system can include multiple components that improve the efficiency and/or controllability of the heat pump system (e.g., an energy recovery ventilator, a dehumidification device, a water side economizer, and/or an air side economizer), which may also be included in the enclosure of the modular heat pump system or may be attachable to the modular heat pump system. Multiple modular heat pump units (e.g., two, three, four, and/or up to 8 heat pump units) can be installed in conjunction with one another and replace a single, large HVAC unit in a building. In this case, one of the heat pump units acts as a primary heat pump unit which includes a master controller that controls the secondary heat pump units to supply the building with heating or cooling under a variety of heating and/or cooling loads (e.g., each of the heat pump units operate in combination to form a combined variable output heat pump system). This system can interface with, and operate independently from, a building management system.

In one form thereof, the present disclosure provides a heat pump system which includes a compressor coupled to a first variable speed motor, a first heat exchanger, a geothermal heat exchanger, a fan coupled to a second variable speed motor, and an expansion device. The heat pump system also includes a refrigerant loop which fluidly couples the compressor, the geothermal heat exchanger, the expansion device, and the first heat exchanger. The heat pump system also includes a controller configured to adjust a first speed of the first variable speed motor, a second speed of the second variable speed motor, and an operation of the expansion device based upon a thermal energy demand.

In another form thereof, the present disclosure provides, a heat pump system that includes a first modular heat pump unit and a second modular heat pump unit. The first modular heat pump unit includes a first compressor coupled to a first variable speed motor, a first heat exchanger; a first geothermal heat exchanger; a first fan coupled to a second variable speed motor; and a first controller in communication with the first variable speed motor and the second variable speed motor. The second modular heat pump unit includes a second compressor coupled to a third variable speed motor, a second heat exchanger, a second geothermal heat exchanger, a second fan coupled to a fourth variable speed motor; and a second controller in communication with the third variable speed motor and the fourth variable speed motor. The heat pump system also includes a third controller in communication with the first controller and the second controller, the third controller configured to adjust a first speed of the first variable speed motor, a second speed of the second variable speed motor, a third speed of the third variable speed motor, and a fourth speed of the fourth variable speed motor based upon a thermal energy demand.

In a further form thereof, the present disclosure provides a system of multiple modular heat pumps where each heat pump includes a variable speed fan, a variable speed compressor, a geothermal heat exchanger, an evaporator/condenser, and a local controller configured to control a speed of the variable speed compressor and a speed of the variable speed fan. At least one of the multiple modular heat pumps is a primary heat pump and further includes a master controller configured to control the speed of each of the variable speed compressors and the variable speed fans based upon a thermal energy demand by control signals communicated to each of the local controllers.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 illustrates a schematic view of a first embodiment of a variable capacity heat pump system.

FIG. 2 illustrates a schematic view of a second embodiment of a variable capacity heat pump system including an energy recovery ventilator.

FIG. 3 illustrates a schematic view of a third embodiment of a variable capacity heat pump system including a dehumidification device.

FIG. 4 illustrates a schematic view of a fourth embodiment of a variable capacity heat pump system including a water side economizer.

FIG. 5 illustrates a schematic view of a fifth embodiment of a variable capacity heat pump system including an air side economizer.

FIG. 6 illustrates a schematic view of a heat pump system including multiple variable capacity heat pumps.

FIG. 7 illustrates a system view of a heat pump system including multiple variable capacity heat pumps sharing a common energy recovery ventilator.

FIG. 8 illustrates a system view of a heat pump system including multiple variable capacity heat pumps.

FIG. 9 illustrates a system view of a heat pump system including multiple variable capacity heat pumps interfacing with additional components of a building management system.

Corresponding reference characters indicate corresponding parts throughout the several views. Although the exemplifications set out herein illustrate embodiments of the invention, the embodiments disclosed below are not intended to be exhaustive or to be construed as limiting the scope of the invention to the precise form disclosed.

### DETAILED DESCRIPTION

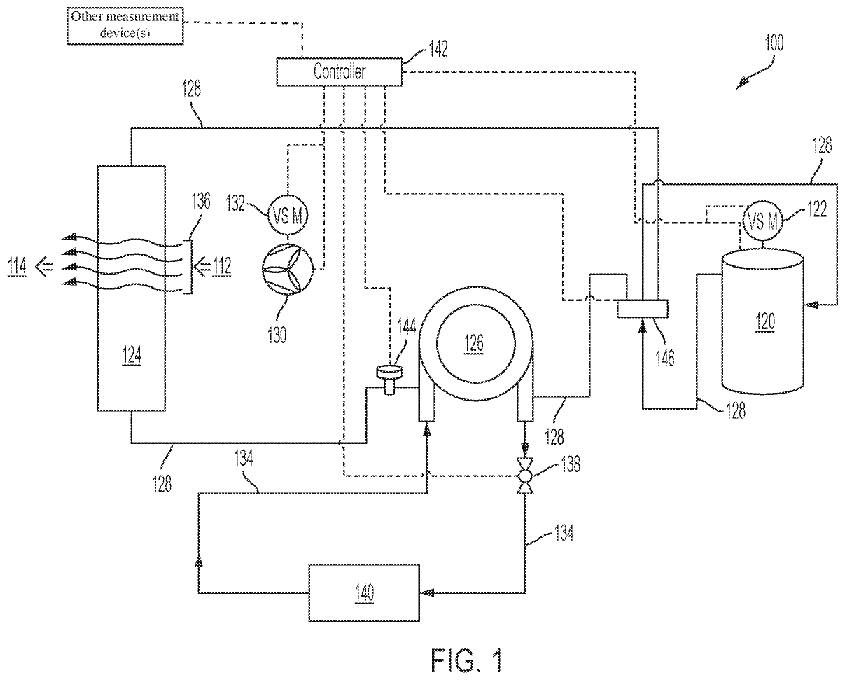

FIG. 1 illustrates a schematic view of a heat pump system 100 in accordance with the present disclosure. Some components of heat pump system 100 may be installed in a building, while other components may be installed externally from the building in the external environment 112. The building may be a commercial structure such as an office building, warehouse, or industrial space, or may be a residential building such as a house, apartment, or condominium. In either case, the building generally includes an internal environment 114 to be heated or cooled in the manner described below.

The heat pump system 100 includes a compressor 120 coupled with a first variable speed motor 122, a first heat exchanger 124, and a geothermal heat exchanger 126, which are all fluidly coupled by a refrigerant loop 128. Heat pump system 100 also includes a geothermal heat sink 140, which is fluidly coupled to the geothermal heat exchanger 126 by fluid loop 134. Heat pump system 100 also includes a fan 130 coupled to second variable speed motor 132. As described herein, heat pump system 100 can be operated in either a cooling mode or heating mode, and supply either cooled or heated air to internal environment 114 under a variety of operational conditions.

Heat pump system 100 includes compressor 120. Compressor 120 may be a single compressor or a bank of several compressors that operate in conjunction with one another. Compressor 120 may be a scroll compressor or alternatively, may be a reciprocating piston compressor, rotary compressor, screw compressor, or other type of compressor which operates to compress a refrigerant working fluid within refrigerant loop 128. Compressor 120 is driven by a first variable speed motor 122. First variable speed motor 122 can operate at a variety of speeds (e.g., motor frequencies), and can be used to vary the speed of compressor 120, and consequently, the flowrate of compressed refrigerant fluid through refrigerant loop 128. For example, first variable speed motor 122 can vary the compression of refrigerant fluid by compressor 120 between a minimum refrigerant fluid flowrate (e.g., corresponding with the minimum operational speed of first variable speed motor 122) and a maximum refrigerant fluid flowrate (e.g., corresponding with the maximum operational speed of first variable speed motor 122). In these cases, the combination of compressor 120 and first variable speed motor 122 can be used to infinitely vary the output of heat pump system 100 across the thermal capacity range of compressor 120.

Heat pump system 100 includes first heat exchanger 124. First heat exchanger 124 is fluidly coupled with compressor 120 and geothermal heat exchanger 126 by refrigerant loop 128, and either heats or cools an air stream 136 supplied from the external environment 112 to the internal environment 114 of the building. For example, during summer months (e.g., when the building requires cooling) first heat exchanger 124 operates as an evaporator, cooling air supplied to the internal environment 114 with liquid refrigerant condensed by geothermal heat exchanger 126, and during winter months (e.g., when the building requires heating), first heat exchanger 124 operates as a condenser, heating air supplied to the internal environment 114 with refrigerant gas received from compressor 120. The heating and/or cooling capacity of the heat pump system 100 is based upon the thermal energy transfer of the refrigerant fluid to the air stream 136 via first heat exchanger 124.

Heat pump system 100 includes fan 130. Fan 130 can be an axial fan such as a propeller, tubeaxial, or vaneaxial type fan, a centrifugal fan, or any other type of fan suitable to supply air to internal environment 114 of the building. Fan 130 is positioned either before first heat exchanger 124 in air stream 136 and used to force fresh air from external environment 112 through first heat exchanger 124 towards internal environment 114, or, (unillustrated) positioned after first heat exchanger 124 and used to draw air stream 136 through first heat exchanger 124 from external environment 112 and force air stream 136 towards internal environment 114.

Fan 130 is driven by a second variable speed motor 132. Second variable speed motor 132 can operate at a variety of speeds (e.g., motor frequencies), and can be used to modulate the speed of fan 130, and consequently, the flowrate of air stream 136 (e.g., the amount of air sent to internal environment 114). For example, second variable speed motor 132 can vary the flowrate of air stream 136 between a minimum air flowrate (e.g., corresponding with the minimum operational speed of second variable speed motor 132) to the maximum air flowrate (e.g., corresponding with the maximum operational speed of second variable speed motor 132) of fan 130. In these cases, the combination of fan 130 and second variable speed motor 132 can be used to infinitely vary the amount of air sent to internal environment 114 across the entire operational air flowrate range of fan 130.

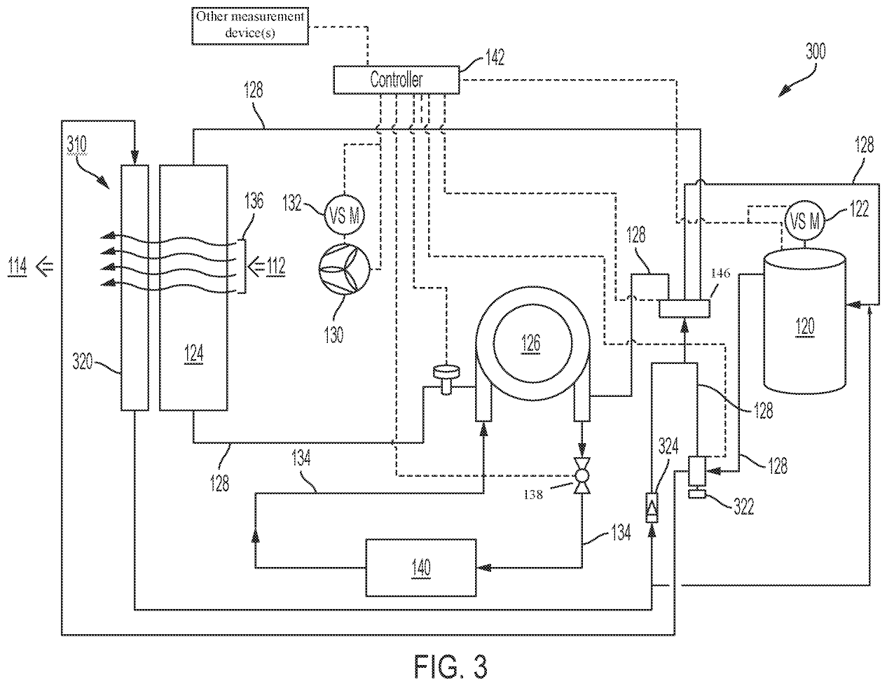

Heat pump system 100 includes geothermal heat exchanger 126, which may be a coaxial refrigerant-to-working fluid type heat exchanger, whereas the working fluid may be selected from a variety of fluids including water, an aqueous solution such as a brine solution, a glycol solution, or any other suitable working fluid. Geothermal heat exchanger 126 includes both a refrigerant side and a working fluid side. The working fluid side of geothermal heat exchanger 126 is in fluid communication with a geothermal heat sink 140 by a fluid loop 134. Isolation valve 138 is used to both initiate and terminate the flow of fluid from the working fluid side of geothermal heat exchanger 126 through fluid loop 134 and into geothermal heat sink 140. In some cases, isolation valve 138 may be an automated on/off valve, or may be a modulated control valve that can vary the flowrate of fluid through fluid loop 134 as well as initiate and/or terminate the flow of working fluid through fluid loop 134. In the case where isolation valve 138 is a modulated control valve, the flowrate of working fluid flowing through fluid loop 134, and therefore the amount of heating or cooling provided by geothermal heat exchanger 126 (e.g., via the amount of heating or cooling provided by the working fluid), can be adjusted based upon a variety of factors including the thermal demand of heat pump system 100, or, in some cases such as those discussed relating to FIG. 3 below, other factors such as the humidity of air stream 136.

Geothermal heat sink 140 may be a geothermal heat sink in which the working fluid is in indirect heat exchange with surrounding soil and/or groundwater, and such as via a earth/ground loop, well, or pond. As such, geothermal heat sink 140 may supply a constant temperature of working fluid to fluid loop 134, which may be, for example, 45° F. Due to the constant temperature of working fluid supplied to fluid loop 134, geothermal heat sink 140 can operate as both a heat source when heat pump system 100 is in the heating mode and a heat sink when heat pump system 100 is in the cooling mode. Although unillustrated, in some cases geothermal heat exchanger 126 may alternatively be a non-geothermal type heat exchanger whereas the fluid side of the non-geothermal heat exchanger 126 is in fluid communication with a non-geothermal heat sink 140 (e.g., such as a cooling tower, a fluid cooler, etc.). In these cases, the non-geothermal heat exchanger 126 functions in the substantially identical manner to geothermal heat exchanger 140 whereas the non-geothermal heat sink 140 operates as both a heat source when heat pump system 100 is in the heating mode and a heat sink when heat pump system 100 is in the cooling mode.

The refrigerant side of geothermal heat exchanger 126 is in fluid communication with first heat exchanger 124 and compressor 120 by refrigerant loop 128. During the cooling mode, vapor refrigerant fluid flows from compressor 120 to a refrigerant inlet of geothermal heat exchanger 126 where geothermal heat exchanger 126 acts as a condenser. In this case, the geothermal heat sink 140 acts as a heat sink where fluid supplied from the geothermal heat sink 140 is used to condense the vapor refrigerant fluid to liquid refrigerant fluid in the refrigerant side of geothermal heat exchanger 126. During the heating mode, liquid refrigerant flows from first heat exchanger 124 to geothermal heat exchanger 126 where geothermal heat exchanger 126 acts as an evaporator. In this case, the geothermal heat sink 140 acts as a heat source where fluid supplied from the geothermal heat sink 140 is used to evaporate the liquid refrigerant fluid to vapor refrigerant fluid in the refrigerant side of geothermal heat exchanger 126. Refrigerant loop 128 carries a suitable refrigerant working fluid and includes conduits fluidly connecting compressor 120, first heat exchanger 124, and the refrigerant side of geothermal heat exchanger 126. Refrigerant loop 128 also includes an expansion device 144 and a four-way valve 146. As described above, heat pump system 100 can operate to supply either heating or cooling to internal environment 114 of the building. In the case where heat pump system 100 operates in a cooling mode, the four-way valve 146 is arranged to supply vapor refrigerant to the suction side of compressor 120 from first heat exchanger 124, whereby the refrigerant is compressed. The compressed refrigerant flows to geothermal heat exchanger 126 where the vapor refrigerant is condensed to liquid refrigerant. The expansion device 144 controls the amount of liquid refrigerant that flows from geothermal heat exchanger 126 to first heat exchanger 124. The liquid refrigerant is evaporated in first heat exchanger 124, and the vapor refrigerant fluid flows to the suction inlet of compressor 120. In the case where heat pump system 100 operates in a heating mode, the four-way valve 146 is arranged to supply vapor refrigerant to first heat exchanger 124, whereby the vapor refrigerant is condensed. The expansion device 144 controls the amount of liquid refrigerant that flows from first heat exchanger 124 to geothermal heat exchanger 126. The liquid refrigerant fluid is evaporated to vapor refrigerant fluid in geothermal heat exchanger 126 and the vapor refrigerant fluid flows to the suction inlet of compressor 120, where the refrigerant fluid is compressed.

Heat pump system 100 includes first controller 142. First controller 142 is in communication with each of compressor 120, first variable speed motor 122, fan 130, second variable speed motor 132, expansion device 144, four-way valve 146, isolation valve 138, and may additionally be in communication with one or more measurement devices located in a variety of locations in relation to heat pump system 100.

For example, first controller 142 may be in communication with one or more measurement devices located in close proximity to, and/or on a component of, heat pump 100, and may also be in communication with one or more measurement devices located in external environment 112 and/or internal environment 114. The measurement devices may supply information relating to temperature, pressure, humidity, air quality (e.g., the carbon dioxide concentration and/or volatile organic compound (VOC) concentration of the air), and/or other suitable information to first controller 142. In some cases, the measurement device may be a single-variable measurement device (e.g., measuring one variable and sending information corresponding to the single measured variable to first controller 142) or may be a multi-variable measurement device (e.g., measuring two or more variables and sending information corresponding to the two or more measured variables to first controller 142). In either case, the measurement device(s) may communicate with first controller 142 by analog communication, digital communication, and/or a combination of analog and digital communication. The communication may be accomplished wirelessly (e.g., short distance radio (Bluetooth) communication, cellular network communication, wireless LAN communication, etc.) or may be accomplished by hard-wired connection between the device and first controller 142.

In a first example, first controller 142 may be in communication with one or more pressure measurement devices (e.g., resistive, capacitive, piezoelectric, optical, and/or micro electro-mechanical system (MEMS) type pressure measurement devices) located in either one of, or any combination of, within refrigerant loop 128, fluid loop 134, an inlet duct supplying fan 130 with air, an inlet of fan 130, an exit of fan 130, an exit duct from fan 130 supplying first heat exchanger 124 with air, in the air stream 136 within first heat exchanger 124, in an exit duct of first heat exchanger 124, and/or at any other location within the ducting system supplying internal environment 114 with air. Each of the one or more pressure measurement devices may supply information relating to air, working fluid, and/or refrigerant pressure to first controller 142 either wirelessly or by hardwired communication. In a second example, first controller 100 may be in communication with one or more temperature measuring devices (e.g., thermocouple, resistive, infrared, bimetallic, thermometer, change-of-state, and/or silicon diode type temperature measurement devices) located in either one of, or any combination of, refrigerant loop 128, fluid loop 134, an inlet duct supplying fan 130 with air, an inlet of fan 130, an exit of fan 130, an exit duct from fan 130 supplying first heat exchanger 124 with air, in the air stream 136 within first heat exchanger 124, an exit duct of first heat exchanger 124, in external environment 112, and/or in internal environment 114. Each of the one or more temperature measurement devices may supply information relating to air, working fluid, and/or refrigerant temperature to first controller 142 either wirelessly or by hardwired communication. In a third example, first controller 142 may be in communication with one or more enthalpy measurement devices which may combinationally measure the temperature and relative humidity of air. The enthalpy measurement device may be located in either one of, or any combination of, an inlet of fan 130, an exit of fan 130, an exit duct from fan 130 supplying first heat exchanger 124 with air, in the air stream 136 within first heat exchanger 124, an exit duct of first heat exchanger 124, in external environment 112, and/or in internal environment 114. Each of the one or more enthalpy measurement devices may supply information to first controller 142 relating to any combination of the temperature, humidity, and/or calculated enthalpy of airstream 136 either wirelessly or by hardwired communication. In a fourth example, first controller 142 may be in communication with one or more air quality measurement devices which measure a variety of variables of the air within internal environment 114 and/or external environment 112, such as volatile organic compound (VOC) concentration, carbon dioxide concentration, or any other measureable concentration of the air. In this case, the air quality measurement devices may be single variable measurement devices (e.g., measuring a single variable concentration within the air), or may be multivariable measurement devices (e.g., measuring the concentrations of multiple variables within the air). Each of the one or more air quality measurement devices may supply information relating to concentrations of variables within the air to first controller 142 either wirelessly or by hardwired communication.

In any of the forgoing cases, the measurement device may be a single-unit combined measurement device which measures any combination of the above described variables. For example, the measurement device may be a thermostat located in internal environment 114. The thermostat may measure the combination of any of the temperature, pressure, relative humidity, VOC concentration, and/or carbon dioxide concentration of the air within internal environment 114, and communicate the information to first controller 142 either by wireless communication (e.g., cellular and/or wireless LAN communication) or by wired communication.

Although unillustrated, and as will be described in further detail herein, first controller 142 may also be in communication with any number of other devices related to the HVAC system, located either within internal environment 114 and or external environment 112. For example, first controller 142 may be in communication with one or more modulated dampers located within internal environment 114, whereas the modulated dampers are controlled to regulate the flow of air within internal environment 114. In this case, first controller 142 may receive information relating to the airflow rate within internal environment 114 based upon the open, closed, or modulated status of the dampers. Additionally, and as will be described in further detail herein, first controller 142 may control the open, closed, and/or partially modulated orientation of each of the dampers based upon a desired air flow within internal environment 114. In this case, first controller 142 may communicate individually with each of the modulated dampers and/or other devices, or may communicate with one or more terminal boxes and/or combined control units (e.g., acting as a common communication connection point for first controller 142 to each of the connected components. In these cases, first controller 114 may be regarded as part of a variable airflow ventilation system, whereas multiple HVAC components are controlled in combination to optimize the HVAC system to meet the cooling/airflow/and or heating load required for a building.

First controller 142 controls each of compressor 120, first variable speed motor 122, fan 130, second variable speed motor 132, expansion device 144, four-way valve 146, and valve 138 according to either a cooling or heating mode. For example, in a cooling mode, first controller 142 controls four-way valve 146 to a position where compressed refrigerant fluid flows from the discharge of compressor 120 through refrigerant loop 128 to an inlet of geothermal heat exchanger 126. First controller 142 also adjusts the position of isolation valve 138 to supply working fluid from geothermal heat sink 140 to geothermal heat exchanger 126 through fluid loop 134. First controller 142 also adjusts the position of expansion device 144 to control the flowrate of refrigerant from geothermal heat exchanger 126 to first heat exchanger 124. In the heating mode, first controller 142 controls four-way valve 146 to a position where compressed refrigerant flows from the discharge of compressor 120 through refrigerant loop 128 to an inlet of first heat exchanger 124. First controller 142 also adjusts the position of isolation valve 138 to supply water from geothermal heat sink 140 to geothermal heat exchanger 126 through fluid loop 134. First controller 142 also adjusts the position of expansion device 144 to control the flowrate of refrigerant from first heat exchanger 124 to geothermal heat exchanger 126.

During either the cooling mode or the heating mode, first controller 142 varies the speed of either, or both of, first variable speed motor 122 and second variable speed motor 132 to modulate the output of heat pump system 100. As described above, each of compressor 120 and fan 130 includes variable speed motors (e.g., first variable speed motor 122 and second variable speed motor 132, respectively). The utilization of the variable speed motors on compressor 120 and fan 130 allow for first controller 142 to vary the output of heat pump system 100 infinitely between a minimum load and a maximum load of either heating or cooling of air stream 136. For example, first controller 142 can vary the flowrate of refrigerant compressed by compressor 120 by adjusting the speed of first variable speed motor 122 simultaneously with the air flowrate outputted by fan 130 by adjusting the speed of second variable speed motor 132. This allows for heat pump system 100 to operate in a range of cooling and heating outputs (e.g., loads) to air stream 136. For example, heat pump system 100 can operate at any load in the cooling mode between a minimum cooling load (e.g., corresponding with the minimum compressor speed and the minimum fan speed) to a maximum cooling load (e.g., corresponding with the maximum compressor speed and the maximum fan speed). Heat pump system 100 can also operate at any load in the heating mode between a minimum heating load (e.g., corresponding with the minimum compressor speed and the minimum fan speed) to a maximum heating load (e.g., corresponding with the maximum compressor speed and the maximum fan speed).

First controller 142 can adjust the output of heat pump system 100 based upon a variety of parameters including any combination of air temperature, air enthalpy (e.g., as based upon relative humidity and/or dew point temperature in combination with measured air temperature), air concentration limits (e.g., VOC, carbon dioxide, etc.), static duct pressure, refrigerant temperature and/or pressure, working fluid temperature, and/or desired total air volume discharged to the building.

In a first example, first controller 142 adjusts the output of heat pump system 100 based upon the temperature of the air entering air stream 136 from the external environment 112. In this case, first controller 142 receives a temperature measurement from a temperature measurement device (e.g., sensor) located in the external environment 112 (not illustrated). First controller 142 compares the measured temperature to a set point temperature, or in some cases, a range of temperatures received from an external device (such as a thermostat, a smartphone, user interface, etc.). Based upon the comparison, first controller 142 determines the appropriate amount of temperature change required for air stream 136 to meet the set point temperature and/or to fall within the range of temperatures. First controller 142 then places the heat pump system 100 into either a heating or cooling mode, and controls each of the connected devices, including the first variable speed motor 122, the second variable speed motor 132, and expansion device 144, to output a thermal load from heat pump system 100 capable of changing the temperature of air stream 136 to meet the set point temperature (or fall within the range of temperatures). For example, first controller 142 may continuously vary the speed which second variable speed motor 132 operates at, and therefore, continuously vary the speed which compressor 120 compresses refrigerant, while simultaneously varying the modulation of expansion device 144. This allows for infinite variability of the compression rate of compressor 120 across the full range of operational capabilities of compressor 120, and the thermal output can be further varied by the modulation of expansion device 144. This gives heat pump system 100 a high degree of flexibility in varying the thermal output to meet a thermal demand. Additionally, first controller 142 can continuously vary the output of heat pump system 100 to meet the set point temperature, or range of temperatures, based upon the continuous measurement of airstream 136 entering heat pump system 100 from external environment 112. Furthermore, in the case where the set point temperature, or range of temperatures, is changed (e.g., via user input, automatically based upon scheduling, etc.), first controller 142 can also reactively and/or continuously vary the output of heat pump system 100 to meet the new temperature or range of temperatures.

In a second example, first controller 142 adjusts the output of heat pump system 100 based upon the enthalpy of the air entering air stream 136 from the external environment 112. In this case, first controller 142 receives an enthalpy measurement either from an enthalpy sensor located in the external environment 112 or calculates an air enthalpy value by a calculation based upon air temperature, dew point temperature and/or relative humidity measurements received from either a single or combined device located in external environment 112. The enthalpy sensor/calculation may sense both the temperature of the incoming air stream 136 from the external environment 112 as well as other factors that may affect the thermal properties of air stream 136, such as the relative humidity of air stream 136. In this case, the sensed enthalpy of air stream 136 accounts for the total internal energy of the air stream 136. The enthalpy sensor can be either a digital or an analog type sensor, and in some cases, many be a solid state enthalpy sensor. The first controller 142 compares the measured enthalpy to an enthalpy set point, or in some cases, an enthalpy range, that is calculated based upon an enthalpy set point received from an external device (such as a thermostat, a smartphone, etc.). Based upon the comparison, first controller 142 determines the appropriate amount of heating or cooling load required to meet the set point enthalpy and/or to fall within the enthalpy range. First controller 142 then places the heat pump system 100 into either a heating or cooling mode, and controls each of the connected devices, including both the first variable speed motor 122 second variable speed motor 132, and expansion device 144 to output a thermal load from heat pump system 100 capable of changing the enthalpy of air stream 136 to meet the set point enthalpy (or fall within the enthalpy range). First controller 142 can also continuously vary the output of heat pump system 100 to meet the set point enthalpy, or range of enthalpies, based upon the continuous measurement of the incoming air enthalpy from external environment 112. In the case where the set point enthalpy, or range of enthalpies is changed, first controller 142 can also continuously vary the output of heat pump system 100 to meet the new enthalpy or range of enthalpies.

In a third example, first controller 142 adjusts the output of heat pump system 100 based upon the comparison of the temperature of the air entering air stream 136 from the external environment 112 with a measured and/or calculated temperature of airstream 136 exiting first heat exchanger 124. As in the first example, first controller 142 receives a temperature measurement from a temperature measurement device located in the external environment 112 (not illustrated). In this case, first controller 142 also receives an air temperature measurement of airstream 136 from a temperature sensor located in either one of, or a combination of, an exit of fan 130, an exit duct from fan 130 supplying first heat exchanger 124 with air, in the air stream within first heat exchanger 124, an exit duct of first heat exchanger 124, and/or internal environment 114, the measurement corresponding to a discharged air temperature from heat pump system 100 to internal environment 114. First controller 142 can additionally or alternatively receive a temperature measurement of the refrigerant from a temperature sensor located at or near a refrigerant outlet of first heat exchanger 124, the temperature measurement corresponding with a calculated temperature of the airstream 136 exiting the air coil of first heat exchanger 124. First controller 142 may also additionally or alternatively receive a pressure measurement from a pressure measurement device located at or near the refrigerant outlet of first heat exchanger 124, where first controller 142 calculates a refrigerant temperature based upon the saturation pressure of the refrigerant exiting the air coil of first heat exchanger 124. In either case, the temperature of the refrigerant can be used to approximate (e.g., calculate) the temperature of the air stream 136 exiting the air coil of first heat exchanger 124. In any of these cases, first controller 142 compares the measured or/or calculated temperature of discharged air stream 136 to the temperature measurement of the external environment 112, and determines a temperature differential between the two measured temperatures. Based upon the temperature differential, first controller 142 determines the appropriate amount of cooling or heating load required to reduce the temperature differential to a threshold value. First controller 142 then places heat pump system 100 into either a heating or cooling mode, and controls each of the connected devices, including both the first variable speed motor 122, the second variable speed motor 132, and the expansion device 144 to output a thermal load from heat pump system 100 capable of changing the temperature of air stream 136 to meet the threshold temperature differential value.

In a fourth example, first controller 142 adjusts the output of heat pump system 100 based upon the comparison of the enthalpy of the air entering air stream 136 from the external environment 112 with the enthalpy measured in the internal environment 114. As in the second example, first controller 142 receives an enthalpy temperature measurement from an enthalpy sensor located in the external environment 112 (not illustrated). In this example, first controller 142 also receives an enthalpy measurement from an enthalpy sensor (or separate temperature and humidity sensors) located in either one, or a combination of, an exit of fan 130, an exit duct from fan 130 supplying first heat exchanger 124 with air, in the air stream within first heat exchanger 124, an exit duct of first heat exchanger 124, and/or in internal environment 114, the measurement corresponding with a discharge air enthalpy of airstream 136. First controller 142 compares the discharged air enthalpy measurement to the enthalpy measurement of the external environment 112 and determines an enthalpy differential between the two measured enthalpies. Based upon the enthalpy differential, first controller 142 determines the appropriate amount of cooling or heating load required to reduce the enthalpy differential to a threshold value. First controller 142 then places the heat pump system 100 into either a heating or cooling mode, and controls each of the connected devices, including both the first variable speed motor 122, the second variable speed motor 132, and the expansion device 144 to output a thermal load from heat pump system 100 capable of changing the enthalpy of air stream 136 to meet the threshold enthalpy differential value.

In a fifth example, first controller 142 can adjust the output of heat pump system 100 based upon both a targeted duct pressure of an air duct supplying internal environment 114 as well as a targeted air temperature and/or enthalpy of airstream 136 discharged from heat pump system 100. As described previously, first controller 142 may receive temperature and/or enthalpy measurements from temperature and/or enthalpy measurement devices located in a variety of locations, the measurement(s) corresponding with the temperature and/or enthalpy of airstream 136 discharged from heat pump system 100 to internal environment 114. In this case, first controller 142 may also receive a pressure measurement from a pressure measurement device located in either one, or any combination of, an exit of fan 130, an exit duct from fan 130 supplying first heat exchanger 124 with air, in the air stream 136 within first heat exchanger 124, and/or in an exit duct of first heat exchanger 124. First controller 142 compares the measured discharge pressure supplied by fan 130 to a pressure set point, or in some cases, a range of discharge pressures that is calculated based upon a pressure set point range received from an external device (such as a thermostat, a smartphone, etc.), either the set point pressure and/or range corresponding with a calculated air flowrate demand. First controller 142 determines the appropriate fan speed needed to reach the discharge pressure, and continuously varies the speed which second variable speed motor 132 operates at to meet the set point pressure. In other words, first controller 142 continuously varies the air flowrate discharged by fan 130 to reach the set point pressure (or range of discharge pressures). As such, first controller 142 can infinitely vary the air flowrate discharged by fan 130, and therefore, the flowrate of airstream 136 supplied to internal environment 114 across the full range of the operational capabilities of fan 130. Additionally, and as described previously, first controller 142 may continuously vary the speed which first variable speed motor 122 operates at, and therefore continuously vary the speed which compressor 120 compresses refrigerant, while simultaneously varying the modulation of expansion device 144. In this case, the combination of the continuous variability of first variable speed motor 122, second variable speed motor 132, and expansion device 144 allows the simultaneous targeting of a discharged duct pressure (e.g., via the operation of fan 130) and a discharged air temperature (e.g., via the operation of compressor 120 and expansion device 144) to meet both a desired air temperature and air flowrate of airstream 136 discharged to internal environment 114.

Alternatively, rather than a single pressure measurement device being used to measure the discharge duct pressure as described in the fifth example above, a combination of two pressure measurement devices, one located at or near the inlet of fan 130 and one at or near the outlet of fan 130 may be used to determine the real-time air flowrate discharged by fan 130, and first controller 142 can adjust the output of heat pump system 100 based upon both a targeted real-time air flowrate and the temperature/enthalpy of an airstream supplying internal environment 114. In this case, the two or more pressure measurement devices may measure a pressure differential across the inlet and outlet of fan 130 (e.g., via a pitot tube), where first controller 130 receives the pressure measurements and determines a real-time air flowrate discharged by fan 130. As in the fifth example above, discharged air temperature/enthalpy may be targeted (e.g., by the continuous variability of first variable speed motor 122 and expansion device 144) and in this case, true air flowrate of airstream 136 may be targeted based upon the real-time airflow measurement (e.g., the pressure differential measurement), rather than an approximated air flowrate based upon discharge duct pressure, as described above.

Although the previous fifth example is described above relating to independent targeting of duct pressure and air flowrate by heat pump system 100, it is also possible to combine system variability based upon any of the foregoing measurements, either alone, or in combination, to achieve a desired thermal output from heat pump system 100. For example, heat pump system 100 may operate in a single zone mode, where leaving air temperature is targeted by the continuous variability of both compressor 120 (e.g., by the operation of first variable speed motor 122 and expansion device 144) and fan 130 (e.g., by the operation of second variable speed motor 132), in a multi-zone mode, where the leaving air pressure is targeted by the continuous variability of fan 130 and the leaving air temperature is targeted by the continuous variability of compressor 120, and/or in a constant airflow mode, where the leaving air flowrate is targeted by the continuous variability of fan 130 and the leaving air temperature is targeted by the continuous variability of compressor 120. In such cases, first controller 142 can place heat pump system 100 into any of the foregoing modes to achieve the desired controllability effect and may move heat pump system 100 into and out of such controllability modes, in real time, based upon system demand and/or external inputs (e.g., user input, scheduling, etc.).

In a sixth example, first controller 142 adjusts the output of heat pump system 100 based upon at least one of the VOC concentration and the carbon dioxide concentration of the air in internal environment 114, measured by an air quality measurement device located in at least one location in internal environment 114. As described previously, first controller 142 may be in communication with one or more air quality measurement devices, which may be located in a variety of locations within internal environment 114. In this case, first controller 142 can continuously vary the output of heat pump system 100 based upon either a targeted air quality value (e.g., a targeted VOC concentration limit and/or carbon dioxide concentration limit), a range of air qualities (e.g., a range of VOC concentration and/or range of carbon dioxide concentration values), and/or an air turnover rate within the internal environment 114 of the building (e.g., a required air flowrate to displace a volume of air within the internal environment 114). Also described previously, first controller 142 may continuously vary the flowrate of air discharged by fan 130 based upon either static duct pressure and/or real-time air flowrate. In either of these cases, first controller 142 may additionally or alternatively vary the discharge of fan 130 based upon a calculated required air flowrate to lower the concentration of the either VOCs and/or carbon dioxide to an acceptable level within internal environment 114 or, in other cases, may vary the discharge of fan 130 based upon a desired air changes per hour (ACPH). The desired ACPH may be based upon scheduling, or in some cases, based upon the measured occupancy of the internal environment 114. For example, first controller 142 may receive a schedule from an external input that sets the ACPH rate for the internal environment 114, which may be based upon an approximated number of occupants of the internal environment 114 of the building (e.g., during business hours, internal environment 114 containing more occupants, and therefore requiring a higher ACPH to remove carbon dioxide buildup from the building). Additionally or alternatively, first controller 114 may receive a measurement of the number of occupants within the internal environment 114 by one or more occupancy sensors within internal environment 114, or by some other determination methods such as building monitoring of occupant flux into/out of the building). In either case, first controller 142 may adjust the air flowrate of airstream 136 discharged by heat pump system 100 to meet the required ACPH rate based upon either or both of the scheduling and/or determined occupancy of the building, which may be used in combination with either, or both of, the air turnover rate and/or carbon dioxide concentration when adjusting the output of heat pump system 100.

Although FIG. 1 illustrates air stream 136 being supplied from external environment 112, in some cases, air may be recirculated from internal environment 114 through a return duct and returned back to heat pump system 100. In this case, VOCs and/or carbon dioxide may accumulate due to the recirculation, and as such, fresh air from external environment 112 is needed to supplement rising concentrations of VOCs and/or carbon dioxide within airstream 136. In this case, heat pump system 100 may include a modulated damper, whereas the damper controls the proportion (e.g., flowrates) of recirculated air supplied to fan 130 from internal environment 114, as compared to fresh air from external environment 112. The proportion of recirculated to fresh air may be based upon the VOC concentration and/or carbon dioxide concentration of internal environment 114, whereas first controller 142 may adjust the position of the modulated damper to supply more fresh air when the VOC concentration and/or carbon dioxide concentration limit is reached. In the case where real-time air flowrate is determined by first controller 142, the position of the damper may correspond with the real-time air flowrate of both the fresh air and the recirculated air, and as such, first controller 100 may adjust the operation of both fan 130 and compressor 120 based upon the real-time air flowrates of both fresh air and recirculated air needed to lower the concentration of either VOCs and/or carbon dioxide to a targeted value.

Heat pump system 100 provides advantages over other heat pump systems. For example, traditional heat pump systems typically include fixed speed motors on compressors and/or fans included with these systems. For example, these heat pumps systems may utilize a compressor which cycles on and off based upon the heating and/or cooling demand of the heat pump system. As such, the output of these fixed-speed heat pump systems are limited to a fixed thermal output (e.g., either heating or cooling), and controllability is limited to that provided by an expansion device in the refrigerant loop. The present heat pump system 100 allows for enhanced controllability, as well as variable capacity, through the use of first variable speed motor 122, expansion device 144, and second variable speed motor 132 all in conjunction with first controller 142. As described previously, first controller 142 can operate heat pump system 100 in either a heating or cooling mode throughout the entire thermal range of heat pump system 100. Additionally, first controller 142 can control first variable speed motor 122 and second variable speed motor 132 based upon various temperature, enthalpy, pressure, air flowrate, and air quality measurements of both the internal environment 114 and the external environment 112. The variable capacity and operational mode flexibility of heat pump system 100 allows for heat pump system 100 to operate more efficiently (e.g., decreasing energy expenditure) and over a wider range of operational parameters, both of which greatly increases the flexibility of heat pump system 100 over traditional heat pump designs.

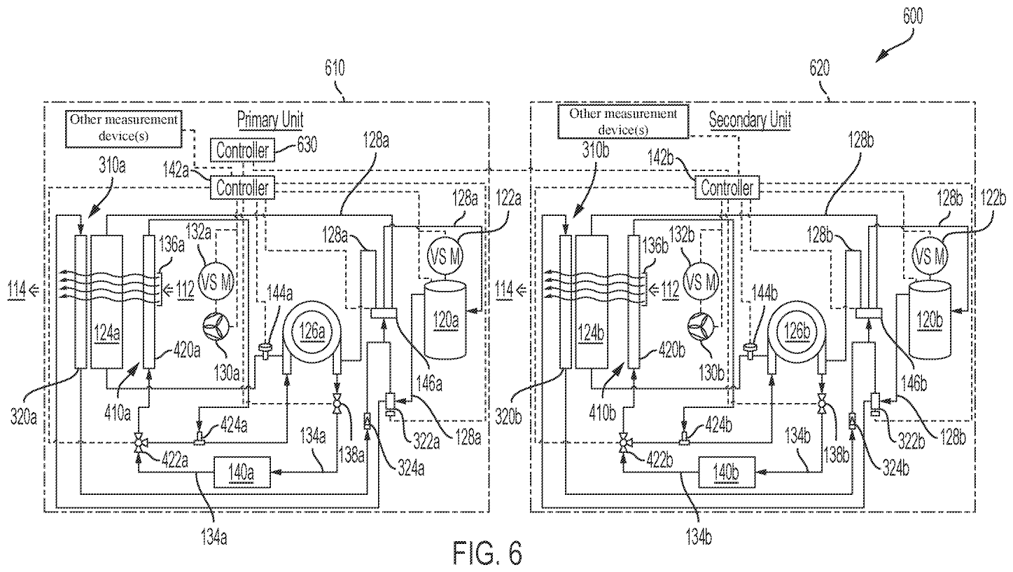

Heat pump system 100 can be built as a modular structure. For example, each of compressor 120, first variable speed motor 122, fan 130, second variable speed motor 132, expansion device 144, refrigerant loop 128, four-way valve 146, and isolation valve 138 can be included in a single modular heat pump system 100, where each of the components are constructed on a skid and/or enclosed within an enclosure. In this case, multiple modular heat pump units can be used to combinationally meet the HVAC requirements of a building, and may be constructed in the same location or in different locations throughout the building. For example, components associated with fan 130 and first heat exchanger 124 may be included in one modular unit, and components associated with compressor 120 and geothermal heat exchanger 126 included in a second modular unit. In this case, the modular units be located separately from one another either in a similar location within a building, or in some cases, in different location either within or outside the building. For example, multiple modular units which include the fan 130 and first heat exchanger 124 may be located at a location associated with the ductwork of the building, while the modular units including the compressor 120 and geothermal heat exchanger 126 may be located in a remote location. In any of these cases, the size of the modular heat pump system 100 can be relatively small, enabling easy movement of modular heat pump system 100 into, out of, and within a building. For example, modular heat pump system 100 can be sized such that the height and width of the modular heat pump system 100 is small enough to fit through a doorway in a building (e.g., a 36 inch standard doorway), or may be sized to accommodate other size constrains (e.g., as based upon the room dimensions within the building, size of a freight elevator, etc.). The size of the modular heat pump system 100 can also allow for multiple modular heat pump systems 100 to be installed within in a building and provide heating and/or cooling in conjunction with one another, as to be described in further detail relating to FIGS. 6-9 below.

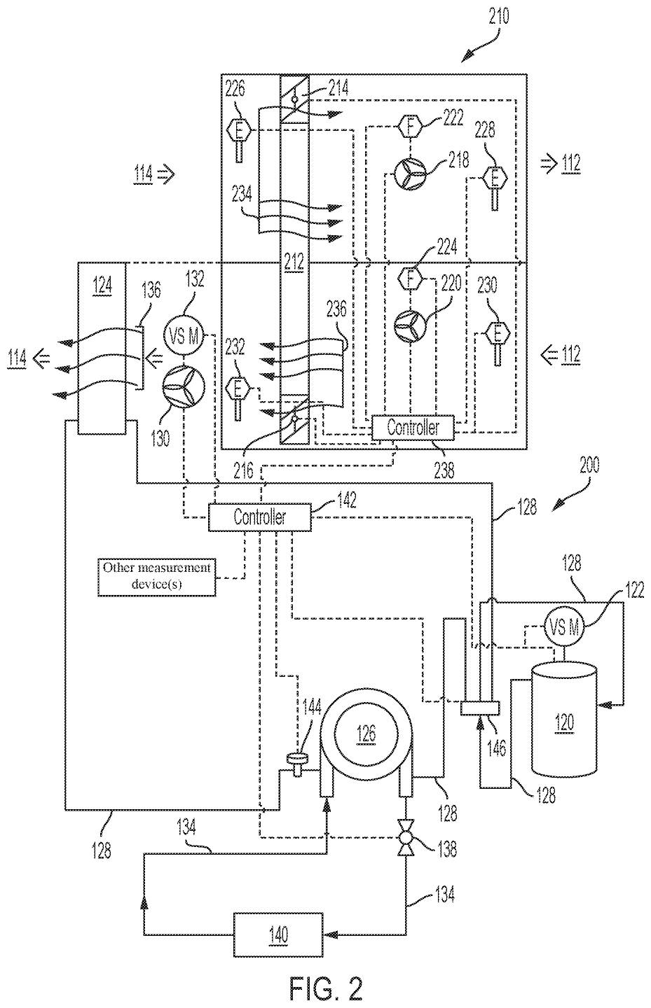

Heat pump system 100 can also include multiple other components in addition to those described above. For example, heat pump system 100 can include an energy recovery ventilator, a heat exchanger to control humidity, a water side economizer, and/or an air side economizer. Each of these embodiments is described in further detail relating to FIGS. 2-5 below.

FIG. 2 is a schematic view of a heat pump system 200 in accordance with the present disclosure. Except as described below, heat pump system 200 is substantially identical to heat pump system 100, where heat pump system 200 includes compressor 120, first variable speed motor 122, fan 130, second variable speed motor 132, expansion device 144, refrigerant loop 128, four-way valve 146, isolation valve 138, and fluid loop 134. Fluid loop 134 may also connect heat pump system 200 to geothermal heat sink 140, which may be the same geothermal heat sink 140 as discussed relating to FIG. 1 above, or may be a different heat sink used by heat pump system 200. Heat pump system 200 also includes first controller 142, which controls each of the components of heat pump system 200 in a similar manner to heat pump system 100 with additional functionality, as discussed herein.

Heat pump system 200 includes energy recovery ventilator 210. Energy recovery ventilator 210 includes an energy exchanger 212, a first damper 214, a second damper 216, a first energy recovery fan 218, a second energy recovery fan 220, a first air flow sensor 222, a second air flow sensor 224, a first exhaust air enthalpy sensor 226, a second exhaust air enthalpy sensor 228, a first fresh air enthalpy sensor 230, a second fresh air enthalpy sensor 232, and an energy recovery ventilator controller 238. Energy recovery ventilator 210 is used to exchange thermal energy from an exhaust stream 234 returned from internal environment 114 with a fresh air stream 236 from external environment 112. The exchange of thermal energy between the two air streams increases the thermal efficiency of heat pump system 200, as discussed herein.

Energy recovery ventilator 210 includes energy exchanger 212. Energy exchanger 212 is a thermal energy exchanger that exchanges enthalpy (e.g., both latent and sensible heating and/or cooling) in exhaust stream 234 from internal environment 114 with fresh air stream 236 from external environment 112 by mixing the energy of the two streams in an internal chamber of energy exchanger 212. For example, when heat pump system 200 is operating in the cooling mode, energy exchanger 212 pre-cools and dehumidifies fresh air stream 236 with exhaust stream 234, and when heat pump system 200 operates in the heating mode, energy exchanger 212 pre-warms and humidifies fresh air stream 236 with exhaust stream 234. Energy exchanger 212 may be an enthalpy wheel, a fixed plate device, a heat pipe, a coil, a thermosiphon, or any other suitable device that transfers enthalpy between the two air streams. Energy recovery ventilator 210 includes first damper 214 and second damper 216 which are used to control the flow of air through energy recovery ventilator 210. First damper 214 is used to control the flow of exhaust stream 234 through a bypass around energy exchanger 212, and second damper 216 is used to control the flow of fresh air stream 236 through a bypass around energy exchanger 212.

Both first damper 214 and second damper 216 may be used in conjunction to control the overall flow of exhaust stream 234 from the internal environment 114 through energy recovery ventilator 210 as well as fresh air stream 236 from external environment 112 through energy recovery ventilator 210.

Energy recovery ventilator 210 includes first energy recovery fan 218 and second energy recovery fan 220. First energy recovery fan 218 may be a variable speed fan which is positioned after energy exchanger 212 in exhaust stream 234 and is used to draw the air in exhaust stream 234 through energy exchanger 212. First energy recovery fan 218 is in communication with first air flow sensor 222, and first air flow sensor 222 is used to monitor the flowrate of exhaust stream 234 drawn through energy exchanger 212. Second energy recovery fan 220 may be a variable speed fan which is positioned before energy exchanger 212 in fresh air stream 236 and is used to force fresh air stream 236 through energy exchanger 212. Second energy recovery fan 220 is in communication with second air flow sensor 224. Second air flow sensor 224 is used to monitor the flowrate of fresh air stream 236 drawn through energy exchanger 212. In some cases, energy recovery ventilator 210 does not include second energy recovery fan 220 (e.g., energy recovery fan 220 may be optional in some embodiments). In this case, fan 130 draws the air in fresh air stream 236 through energy exchanger 212 rather than second energy recovery fan 220 forcing the air in air stream 236 through energy exchanger 212.

Energy recovery ventilator 210 includes first exhaust air enthalpy sensor 226, second exhaust air enthalpy sensor 228, first fresh air enthalpy sensor 230, and second fresh air enthalpy sensor 232. Each of the enthalpy devices is used to measure the enthalpies (e.g., both temperature and humidity) of the air streams before entering, and after exiting, energy exchanger 212. For example, first exhaust air enthalpy sensor 226 is positioned before energy exchanger 212 and measures the enthalpy of exhaust stream 234 before entering energy exchanger 212. Second exhaust air enthalpy sensor 228 is positioned after energy exchanger 212 and measures the enthalpy of exhaust stream 234 after exiting energy exchanger 212. Both first exhaust air enthalpy sensor 226 and second exhaust air enthalpy sensor 228 can be used to determine an enthalpy differential between the inlet and outlet of the exhaust stream 234 through energy exchanger 212 (e.g., the difference in the enthalpy of exhaust stream 234 as measured before and after entering energy exchanger 212). Additionally, first fresh air enthalpy sensor 230 is positioned before energy exchanger 212 and measures the enthalpy of fresh air stream 236 before entering energy exchanger 212. Second fresh air enthalpy sensor 232 is positioned after energy exchanger 212 and measures the enthalpy of fresh air stream 236 after exiting energy exchanger 212. Both first fresh air enthalpy sensor 230 and second fresh air enthalpy sensor 232 can be used to determine an enthalpy differential between the inlet and outlet of the fresh air stream 236 through energy exchanger 212 (e.g., the difference in the enthalpy of fresh air stream 236 as measured before and after entering energy exchanger 212). Both the enthalpy measurements and the differential enthalpies, as measure by all four enthalpy sensors, can be used to control heat pump system 200, as discussed in further detail relating to energy recovery ventilator controller 238 and first controller 142 herein.

Energy recovery ventilator 210 includes energy recovery ventilator controller 238. Energy recovery ventilator controller 238 is in communication with each of first damper 214, second damper 216, first energy recovery fan 218, second energy recovery fan 220, first air flow sensor 222, second air flow sensor 224, first exhaust air enthalpy sensor 226, second exhaust air enthalpy sensor 228, first fresh air enthalpy sensor 230, and second fresh air enthalpy sensor 232, and controls the operation of energy recovery ventilator 210 through controlling each of first damper 214, second damper 216, first energy recovery fan 218, and second energy recovery fan 220. For example, energy recovery ventilator controller 238 controls the operation (e.g., speed) of first energy recovery fan 218 and first damper 214 to regulate the air flow of exhaust stream 234 flowing through energy recovery ventilator 210. Energy recovery ventilator controller 238 also controls the operation (e.g., speed) of second energy recovery fan 220 (or in the case where energy recovery ventilator 210 does not include second energy recovery fan 220, the speed of fan 130) and second damper 216 to regulate the air flow of fresh air stream 236 flowing through energy recovery ventilator 210. The control of the flow of exhaust stream 234 and fresh air stream 236 may be based upon the differential enthalpies determined by energy recovery ventilator controller 238 as discussed above. Energy recovery ventilator controller 238 controls each of the components of energy recovery ventilator 210 to output a fresh air stream 236 with a targeted (e.g., set point) enthalpy, which supplies first heat exchanger 124 as incoming air stream 136. Energy recovery ventilator controller 238 communicates with first controller 142, and in some cases, receives control signals from first controller 142 to control all of, or some of, the components of energy recovery ventilator 210. Energy recovery ventilator controller 238 also communicates operational information (e.g., enthalpy measurements, power levels, fan and damper status, etc.) to first controller 142.

As discussed relating to heat pump system 100, first controller 142 controls each of compressor 120, first variable speed motor 122, fan 130, second variable speed motor 132, expansion device 144, four-way valve 146, and isolation valve 138 according to either a cooling or heating mode where the thermal output of the heat pump system is based upon a variety of temperature, enthalpy, pressure, and/or air quality measurements used to determine the thermal demand and/or air demand of an interior space of the building. In the case of heat pump system 200, first controller 142 also communicates with energy recovery ventilator controller 238, and further controls heat pump system 200 based upon the operation of energy recovery ventilator 210 as well as temperature and/or enthalpy measurements received from energy recovery ventilator controller 238. For example, first controller 142 can further control the speed of both first variable speed motor 122 and second variable speed motor 132 to modulate the output of heat pump system 100 based upon the operation of the energy recovery ventilator 210. In this case, the operation of energy recovery ventilator 210 may change the inlet enthalpy of air stream 136 to heat pump system 200 as compared to a fresh air stream originating from the external environment 112. Enthalpy measurements measured by energy recovery ventilator 210 may also be used in addition to, or alternatively to, the temperature and/or enthalpy measurements of the internal environment 114 and/or external environment 112, as discussed relating to heat pump system 100 above, to adjust the output of heat pump system 200. Through the use of energy recovery ventilator 210 the overall energy demand of heat pump system 200 is reduced since energy in the exhaust stream that otherwise would be wasted is now recycled into the internal environment 114.

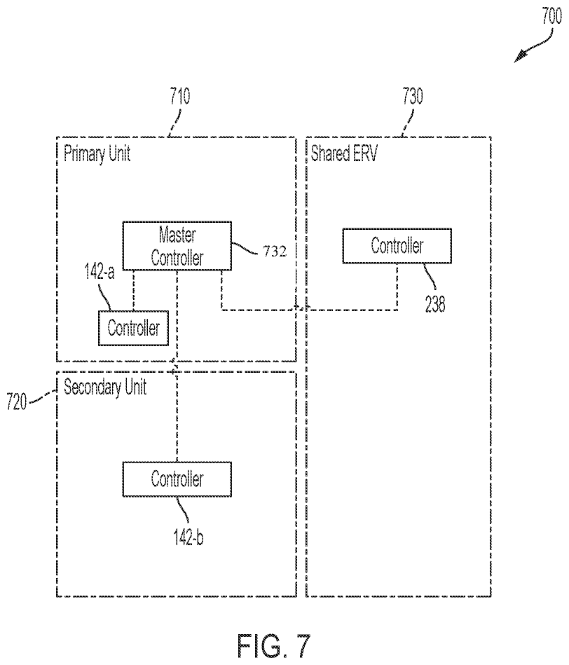

As with heat pump system 100, heat pump system 200 may also be a modular heat pump system, and energy recovery ventilator 210 may also be designed to fit within the modular structure of modular heat pump system 200 or attachable to modular heat pump system 200 once modular heat pump system 200 is installed in a building. In some cases, energy recovery ventilator 210 may also be shared between multiple modular heat pump systems, as discussed relating to FIG. 7 below.

FIG. 3 illustrates a schematic view of a heat pump system 300 in accordance with the present disclosure. Except as described below, heat pump system 300 is substantially identical to heat pump system 100, where heat pump system 300 includes compressor 120, first variable speed motor 122, fan 130, second variable speed motor 132, expansion device 144, refrigerant loop 128, four-way valve 146, isolation valve 138, and fluid loop 134. Fluid loop 134 may also connect heat pump system 300 to geothermal heat sink 140, which may be the same geothermal heat sink 140 as discussed relating to FIG. 1 above, or may be a different heat sink used by heat pump system 300. Heat pump system 300 also includes first controller 142, which controls each of the components of heat pump system 300 in a similar manner to heat pump system 100 with additional functionality, as discussed below.

Heat pump system 300 includes humidity control device 310. Humidity control device 310 includes a humidity control heat exchanger 320, three way valve 322, check valve 324, and may include refrigerant control valve 325. Humidity control device 310 is used to control the humidity of air stream 136 entering internal environment 114 through the dehumidification of air stream 136 after it has been cooled by first heat exchanger 124.

Humidity control device 310 includes humidity control heat exchanger 320. Humidity control heat exchanger 320 is positioned after the first heat exchanger 124 in air stream 136, and is fluidly coupled with an outlet of compressor 120 through two fluid couplings, the first through three way valve 322, and the second through check valve 324. As described relating to heat pump system 100, during the cooling mode, the discharged refrigerant vapor from compressor 120 flows to geothermal heat exchanger 126 through refrigerant loop 128, whereby it is condensed. In the case of heat pump system 300, refrigerant loop 128 is fluidly coupled to three way valve 322, where three way valve 322 is positioned prior to the vapor refrigerant inlet of four-way valve 146 in refrigerant loop 128. Three way valve 322 is operated to divert some of the vapor refrigerant flowing towards geothermal heat exchanger 126 to an inlet of humidity control heat exchanger 320. The vapor refrigerant flows into humidity control heat exchanger 320 and is used to dehumidify air stream 136 after it has been cooled by first heat exchanger 124. The dehumidification of air stream 136 is accomplished without sensible heating of air stream 136 as the heat in the vapor refrigerant is used to decrease the relative humidity of air stream 136 without warming air stream 136. The vapor refrigerant flows from humidity control heat exchanger 320 and may flow to control valve 325. In this case, control valve 325 is used to modulate the amount of vapor refrigerant that is diverted from geothermal heat exchanger 126 towards humidity control heat exchanger 320. The amount of vapor refrigerant flowing to humidity control heat exchanger 320 may be based upon the required amount of thermal energy (e.g., the amount of heating) needed to dehumidify airstream 136. The vapor refrigerant also flows from humidity control heat exchanger 320 to check valve 324. Check valve 324 is fluidly coupled with refrigerant loop 128, and the refrigerant flows through check valve 324 and back into refrigerant loop 128. Check valve 324 also prevents backflow of vapor refrigerant towards humidity control heat exchanger 320.

As discussed relating to heat pump system 100, first controller 142 controls each of compressor 120, first variable speed motor 122, fan 130, second variable speed motor 132, expansion device 144, four-way valve 146, and isolation valve 138 according to either a cooling or heating mode where the thermal output of heat pump system is based upon a variety of temperature, enthalpy, pressure, and/or air quality measurements used to determine the thermal demand and/or air demand of an interior space 114 of the building. In the case of heat pump system 300, first controller 142 further communicates with three way valve 322 and control heat pump system 300 based upon the operation of humidity control device 310. For example, first controller 142 can further control the speed of both first variable speed motor 122 and second variable speed motor 132 to modulate the output of heat pump system 100 based upon the operation of the humidity control device 310. For example, first controller 142 can also control the humidity of air stream 136 by the operation of both three way valve 322 and isolation valve 138 during the cooling mode. The operation of three way valve 322 and isolation valve 138 may be based on an enthalpy measurement of air stream 136 either after exiting humidity control heat exchanger 320, by a comparison of the enthalpy of airstream 136 entering first heat exchanger 124 and after exiting humidity control heat exchanger 320, by a temperature measurement of refrigerant within and/or exiting first heat exchanger 124, or by some other enthalpy and/or humidity measurement of air stream 136. For example, first controller 142 may control isolation valve 138, which in this case, may be a modulating control valve, such that the amount of fluid flowing through geothermal heat exchanger 126 is varied based upon the saturation temperature of vapor refrigerant exiting compressor 120. In this case, the modulation of both three way valve 322 and isolation valve 138 may optimize the operation of dehumidification heat exchanger 320 such that the saturation temperature of refrigerant exiting compressor 120 is maintained (e.g., by the amount of cooling supplied to vapor refrigerant by the working fluid in fluid loop 134) while achieving the desired level of dehumidification of airstream 136 (e.g., as based upon the enthalpy measurement of airstream 136).

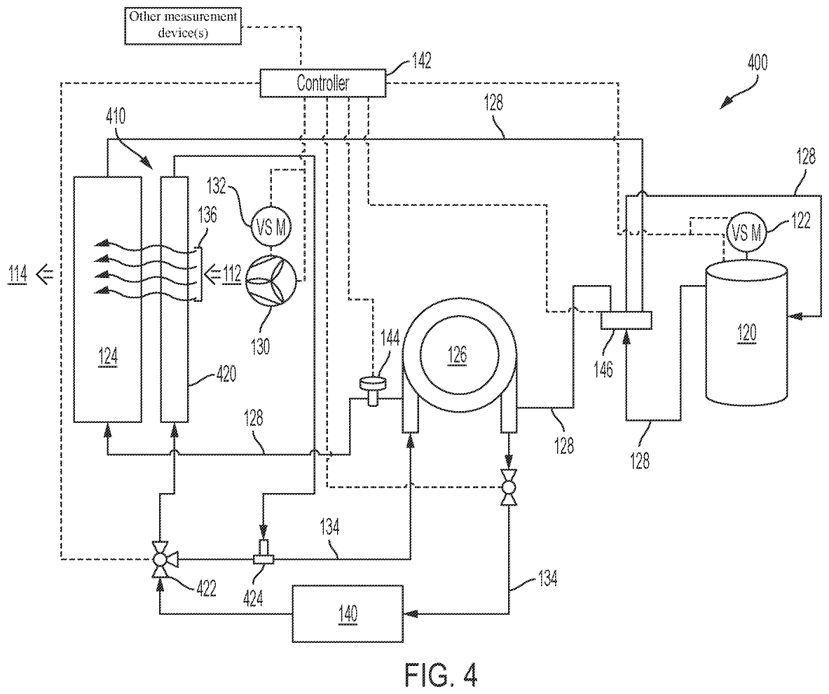

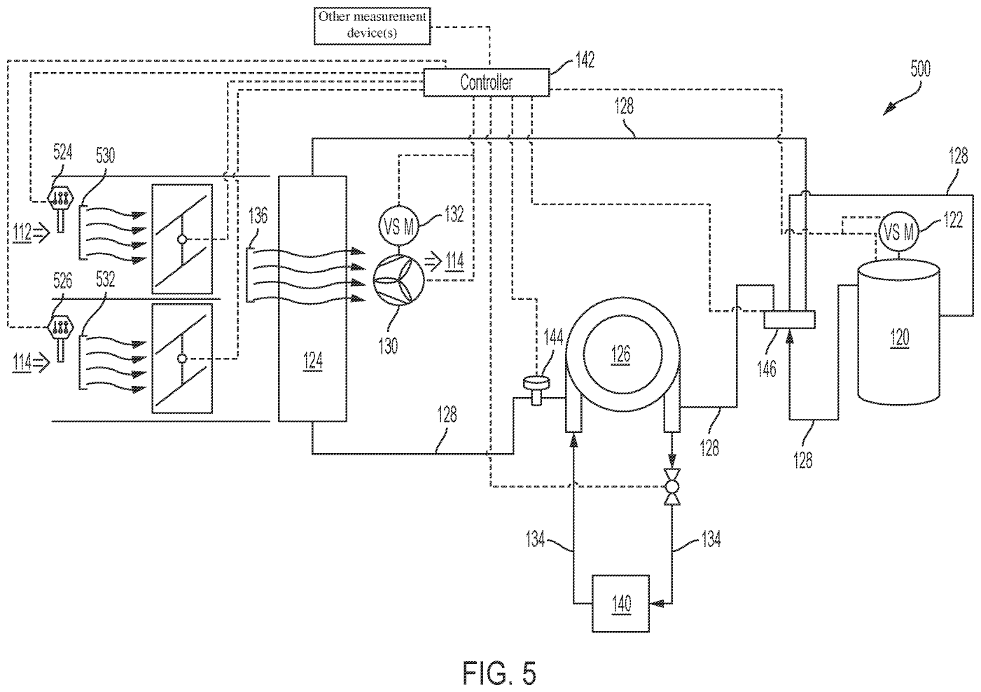

As with heat pump system 100, heat pump system 300 may also be a modular heat pump system, and humidity control device 310 may also be designed to fit within the modular structure of modular heat pump system 300, or in some cases, attachable to modular heat pump system 300, either before, or once modular heat pump system 300 is installed in a building. Additionally, heat pump system 300 may include additional features such as the energy recovery ventilator as discussed in relation to FIG. 2 above, a water side economizer as discussed in relation to FIG. 4 below, and/or and air side economizer, as discussed with reference to FIG. 5 below.

FIG. 4 is a schematic view of a heat pump system 400 in accordance with the present disclosure. Except as described below, heat pump system 400 is substantially identical to heat pump system 100, where heat pump system 400 includes compressor 120, first variable speed motor 122, fan 130, second variable speed motor 132, expansion device 144, refrigerant loop 128, four-way valve 146, isolation valve 138, and fluid loop 134. Fluid loop 134 may also connect heat pump system 400 to geothermal heat sink 140, which may be the same geothermal heat sink 140 as discussed relating to FIG. 1 above, or may be a different heat sink used by heat pump system 400. Heat pump system 400 also includes first controller 142, which controls each of the components of heat pump system 400 in a similar manner to heat pump system 100 with additional functionality, as discussed below.

Heat pump system 400 includes water side economizer device 410. Water side economizer device 410 includes an economizing heat exchanger 420, a three way valve 422, and tee 424. Water side economizer device 410 is used to pre-cool or pre-warm air stream 136 entering first heat exchanger 124 from external environment 112.

Water side economizer device 410 includes economizing heat exchanger 420. Economizing heat exchanger 420 is positioned before the air inlet of first heat exchanger 124 in air stream 136, and is fluidly coupled with the fluid outlet of geothermal heat sink 140 by two fluid couplings with fluid loop 134, the first through three way valve 422, and the second through tee 424. As described relating to heat pump system 100, the fluid side of geothermal heat exchanger 126 is in fluid communication with a geothermal heat sink 140 by fluid loop 134. Isolation valve 138 is used to both initiate and terminate the flow of working fluid from the water side of geothermal heat exchanger 126 through fluid loop 134 and into geothermal heat sink 140, and in some cases, may modulate isolation valve 138 to control the flowrate of fluid through the fluid loop 134. In the case of system 400, fluid loop 134 is fluidly coupled to three way valve 422, where three way valve 422 is positioned prior to the water inlet of geothermal heat exchanger 126 in fluid loop 134. Three way valve 422 is operated to divert some of the water flowing towards geothermal heat exchanger 126 within fluid loop 134 to an inlet of economizing heat exchanger 420. The water flows through economizing heat exchanger 420 and is used to either pre-warm or pre-cool air stream 136 before air stream 136 enters first heat exchanger 124. The water then flows from economizing heat exchanger 420 to tee 424. Tee 424 is positioned after the connection to three way valve 422 in fluid loop 134 supplying geothermal heat exchanger 126 with water. Water flowing from economizing heat exchanger 420 is discharged through tee 424 back into fluid loop 134 supplying geothermal heat exchanger 126 with water.

As discussed relating to heat pump system 100, first controller 142 controls each of compressor 120, first variable speed motor 122, fan 130, second variable speed motor 132, expansion device 144, four-way valve 146, and isolation valve 138 according to either a cooling or heating mode where the thermal output of the heat pump system is based upon a variety of temperature, enthalpy, pressure, and/or air quality measurements used to determine the thermal demand and/or air demand of an interior space of the building. In the case of heat pump system 400, first controller 142 further communicates with three way valve 422, and controls heat pump system 400 based upon the operation of water side economizer device 410. For example, first controller 142 is further configured to control the speed of both first variable speed motor 122 and second variable speed motor 132 to modulate the output of heat pump system 400 based upon the operation of water side economizer device 410. First controller 142 is also configured to control three way valve 422 and to pre-cool or pre-warm air stream 136 from external environment 112 with water side economizer device 410. In some cases, first controller 142 can also control the order in which the components of heat pump system 400 are brought on and off line, and specifically when the components associated with water side economizer device 400 are brought online in relation to compressor 120. For example, in some cases, water side economizer device 420 may be brought online before compressor 120.

As a first example, during the cooling mode, first controller 142 can operate three way valve 422 to divert water from fluid loop 134 to economizing heat exchanger 420 when the temperature of the water in fluid loop 134 is less than the temperature of air stream 136. In this case, economizing heat exchanger 420 may pre-cool air stream 136, and a measurement of the temperature and/or enthalpy of air stream 136 (e.g., taken prior to air stream 136 entering first heat exchanger 124 and/or after the exit of air stream 136 from first heat exchanger 124) is used by first controller 142 to control the amount of water flowing through economizing heat exchanger 420. Additionally, first controller 142 may adjust either, or both of, the first variable speed motor 122 and the second variable speed motor 132 based upon the amount of cooling provided to air stream 136 by water side economizer device 410 since the air stream 136 has been pre-cooled prior to entering first heat exchanger 124 (e.g., the amount of cooling of air stream 136 has been reduced by water side economizer device 410).

As a second example, during the heating mode, first controller 142 can operate three way valve 422 to divert water from fluid loop 134 to economizing heat exchanger 420. In this case, economizing heat exchanger 420 may pre-warm air stream 136, and a measurement of the temperature and/or enthalpy of air stream 136 (e.g., taken prior to air stream 136 entering first heat exchanger 124 and/after the exit of air stream 136 from first heat exchanger 124) is used by first controller 142 to control the amount of water flowing through economizing heat exchanger 420. Additionally, first controller 142 may adjust either, or both of, the first variable speed motor 122 and the second variable speed motor 132 based upon the amount of warming provided to air stream 136 by water side economizer device 410 since the air stream 136 has been pre-warmed prior to entering first heat exchanger 124 (e.g., the amount of heating of air stream 136 has been reduced by water side economizer device 410).

By pre-cooling air stream 136 during the cooling mode and/or pre-warming air stream 136 during the warming mode, the overall energy efficiency of heat pump system 400 is increased because the heating and/or cooling of air stream 136 is at least partially based on the constant temperature of the water in fluid loop 134 warming or cooling air stream 136. Therefore, heat pump system 400 may be more efficient than other heat pump systems since the power consumption of compressor 120 in heat pump system 400 may be reduced as compared with other heat pump systems.

As with heat pump system 100, heat pump system 400 may also be a modular heat pump system, and water side economizer device 410 may also be designed to fit within the modular structure of modular heat pump system 400, or in some cases, attachable to modular heat pump system 400 either prior to, or once modular heat pump system 400 is installed in a building. Additionally, heat pump system 400 may include additional features such as the energy recovery ventilator as discussed in relation to FIG. 2 above, a humidity control device as discussed in relation to FIG. 3 above, and/or and air side economizer, as discussed with reference to FIG. 5 below.

FIG. 5 is a schematic view of a heat pump system 500 in accordance with the present disclosure. Except as described below, heat pump system 500 is substantially identical to heat pump system 100, where heat pump system 500 includes compressor 120, first variable speed motor 122, fan 130, second variable speed motor 132, expansion device 144, refrigerant loop 128, four-way valve 146, isolation valve 138, and fluid loop 134. Fluid loop 134 may also connect heat pump system 500 to geothermal heat sink 140, which may be the same geothermal heat sink 140 as discussed relating to FIG. 1 above, or may be a different heat sink used by heat pump system 500. Heat pump system 500 also includes first controller 142, which controls each of the components of heat pump system 500 in a similar manner to heat pump system 100 with additional functionality, as discussed herein.

Heat pump system 500 includes air side economizer device 510. Air side economizer device 510 includes a first damper 520, a second damper 522, an exhaust air enthalpy sensor 526 and a fresh air enthalpy sensor 524. Air side economizer device 510 is used to mix an exhaust stream 532 returned from internal environment 114 with a fresh air stream 530 from external environment 112 in order to recycle thermal energy within exhaust stream 532. The exchange of thermal energy between the two air streams increases the efficiency of heat pump system 400, as discussed below.

Air side economizer device 510 is positioned in air stream 136 prior to first heat exchanger 124. As illustrated in FIG. 5, fan 130 may be positioned after first heat exchanger 124 in air stream 136, or, in some cases, positioned between air side economizer device 510 and first heat exchanger 124 (unillustrated). Air side economizer device 510 includes first damper 520 and second damper 522. First damper 520 is positioned in fresh air stream 530, and is used to control the flow of fresh air stream 530 to first heat exchanger 124. Second damper 522 is positioned in exhaust stream 532, and is used to control the flow of exhaust air stream 532 to first heat exchanger 124. Both first damper 520 and second damper 522 can be operated in conjunction to control the overall flow of air stream 136 to first heat exchanger 124 based upon the enthalpies of each air stream entering air side economizer device 510.

Air side economizer device 510 includes a fresh air enthalpy sensor 524 and an exhaust air enthalpy sensor 526. Each of the enthalpy devices is used to measure the enthalpy (e.g., both temperature and humidity) of the air streams entering air side economizer device 510. For example, fresh air enthalpy sensor 524 is positioned before first damper 520, and measures the enthalpy of fresh air stream 530 entering air side economizer device 510 from external environment 112. Exhaust air enthalpy sensor 526 is positioned before second damper 522, and measures the enthalpy of exhaust stream 532 entering air side economizer device 510 from internal environment 114. The measured enthalpies of the two air streams may be compared with one another to determine the positions of each of first damper 520 and second damper 522 so that an overall enthalpy of air stream 136 is met by mixing the two air streams.

As discussed relating to heat pump system 100, first controller 142 controls each of compressor 120, first variable speed motor 122, fan 130, second variable speed motor 132, expansion device 144, four-way valve 146, and isolation valve 138 according to either a cooling or heating mode where the thermal output of the heat pump system is based upon a variety of temperature, enthalpy, pressure, and/or air quality measurements used to determine the thermal demand and/or air demand of an interior space of the building. In the case of heat pump system 500, first controller 142 further communicates with each of first damper 520, second damper 522, exhaust air enthalpy sensor 526, and fresh air enthalpy sensor 524, and first controller 142 is further configured to control the speed of both first variable speed motor 122 and second variable speed motor 132 to modulate the output of heat pump system 500 based upon the operation of air side economizer device 510. First controller 142 also controls the operation of air side economizer device 510 through controlling each of first damper 520 and second damper 522.

For example, first controller 142 controls the operation of first damper 520 to regulate the air flow of fresh air stream 530 flowing through air side economizer device 510. First controller 142 also controls the operation of second damper 522 to regulate the air flow of exhaust stream 532 flowing through air side economizer device 510. The control of the flow of fresh air stream 530 and exhaust stream 532 may be based upon a differential enthalpy determined by first controller 142 calculated based on a comparison of the enthalpy measurements received from exhaust air enthalpy sensor 526 and fresh air enthalpy sensor 524. For example, first controller 142 compares the enthalpy measurement of fresh air stream 530 (e.g., as measured by fresh air enthalpy sensor 524) to the enthalpy measurement of exhaust stream 532 (e.g., as measured by exhaust air enthalpy sensor 526) to determine the enthalpy differential between the two air streams. First controller 142 may then determine a target enthalpy for air stream 136, which may be based upon the enthalpy and/or temperature measurements measured for either the external environment 112 and/or internal environment 114, as discussed relating to FIG. 1 above. First controller 142 may then adjust the positions of each of first damper 520 and second damper 522 so that the target enthalpy of air stream 136 is achieved with both fresh air stream 530 and exhaust stream 532.

The enthalpy of air stream 136 may be adjusted by first controller 142 during either the cooling or heating mode such that the enthalpy of air stream 136 lowers the overall energy consumption of heat pump system 500. For example, during the cooling mode, first controller 142 may target a lower enthalpy of air stream 136 (e.g., a cooler and/or less humid air stream 136) and may adjust the position of second damper 522 to allow more air flow of exhaust stream 532 from the internal environment 114 when the air returning from internal environment 114 is cooler and/or less humid than the air in fresh air stream 530 flowing from external environment 112. In this case, the overall cooling load of heat pump system 500 is decreased as compared to other heat pump systems since less cooling of air stream 136 is required. During the heating mode, first controller 142 may target a higher enthalpy of air stream 136 (e.g., a warmer and/or more humid air stream 136) and may adjust the position of second damper 522 to allow more air flow of exhaust stream 532 from the internal environment 114 when the air returning from internal environment 114 is warmer and/or more humid than the air in fresh air stream 530 flowing from external environment 112. In this case, the overall heating load of heat pump system 500 is decreased as compared to other heat pump systems since less cooling of air stream 136 is required.

As with heat pump system 100, heat pump system 500 may also be a modular heat pump system, and air side economizer device 510 may also be designed to fit within the modular structure of modular heat pump system 500, or in some cases, attachable to modular heat pump system 500 either before or once modular heat pump system 500 is installed in a building. Additionally, heat pump system 500 may include additional features such as a humidity control device as discussed in relation to FIG. 3 above, and/or a water side economizer device as discussed in relation to FIG. 4 above.

FIG. 6 is a schematic view of a heat pump system 600 in accordance with the present disclosure. Heat pump system 600 is a system of multiple heat pumps, where each heat pump includes either some of, or all of, the features and functionality relating to FIGS. 1-5, as described above. For example, first heat pump unit 610 includes a compressor 120-a, a first variable speed motor 122-a, a fan 130-a, a second variable speed motor 132-a, an expansion device 144-a, a refrigerant loop 128-a, a four-way valve 146-a, an isolation valve 138-a, a fluid loop 134-a, and a first controller 142-a, where each component includes the features and functionality as described relating to heat pump system 100 in FIG. 1 above. Heat pump system 600 also includes humidity control device 310-a including a humidity control heat exchanger 320-a, a three way valve 322-a, a control valve 325-a, and a check valve 324-a, where each component includes the features and functionality as described relating to heat pump system 300 in FIG. 3 above. Heat pump system 600 also includes water side economizer device 410-a including an economizing heat exchanger 420-a, a three way valve 422-a, and a tee 424-a, where each component includes the features and functionality relating to heat pump system 400 as described in FIG. 4 above.

Second heat pump unit 620 includes a compressor 120-b, a first variable speed motor 122-b, a fan 130-b, a second variable speed motor 132-b, an expansion device 144-b, a refrigerant loop 128-b, a four-way valve 146-b, an isolation valve 138-b, a fluid loop 134-b, and a second controller 142-b, where each component includes the features and functionality as described relating to heat pump system 100 in FIG. 1 above. Second heat pump unit 620 also includes humidity control device 310-b including a humidity control heat exchanger 320-b, a three way valve 322-b, a control valve 325-b, and a check valve 324-b, where each component includes the features and functionality as described relating to heat pump system 300 in FIG. 3 above. Second heat pump unit 620 also includes water side economizer device 410-b including an economizing heat exchanger 420-b, a three way valve 422-b, and a tee 424-b where each component includes the features and functionality as described relating to heat pump system 400 in FIG. 4 above.

Although unillustrated, first heat pump unit 610 and/or second heat pump unit 620 may include additional components such as an air-side economizer (e.g., including first dampers 520-a and/or 520-b and/or second dampers 522-a and/or 522-b as well as exhaust air enthalpy sensors 526-a and/or 526-b and fresh air enthalpy sensors 524-a and/or 524-b). Furthermore, although first heat pump unit 610 and second heat pump unit 620 are illustrated as including humidity control device 310-a/310-b and water side economizer device 410-a/410-b, in some cases, either, or both of these devices may not be present on either, or both of, first heat pump unit 610 and second heat pump unit 620.

Each of first heat pump unit 610 and/or second heat pump unit 620 also include water loops connected to geothermal water sinks (e.g., first heat pump 610 including fluid loop 134-a connecting geothermal heat exchanger 126-a to geothermal heat sink 140-a, second heat pump unit 620 including fluid loop 134-b connecting geothermal heat exchanger 126-b to geothermal heat sink 140-b). In some cases, geothermal heat sinks 140-a and 140-b may be separate geothermal heat sinks supplying water to each heat pump unit. However, in some cases (not illustrated), geothermal heat sink 140-a and geothermal heat sink 140-b may be the same geothermal heat sink, where water piping interconnects common geothermal heat sink 140 with first heat pump unit 610 and second heat pump unit 620.

Heat pump system 600 includes third controller 630. Third controller 630 acts as the master controller for heat pump system 600 and controls each of the components of heat pump system 600 through communication with first controller 142-a and second controller 142-b. For example, third controller 630 receives operational information relating to first heat pump unit 610 and second heat pump unit 620 from first controller 142-a and second controller 142-b respectively. Third controller 630 processes the operational information and sends control commands to both first controller 142-a and second controller 142-b, which control each of the components of first heat pump unit 610 and second heat pump unit 620 respectively. In this case, both first controller 142-a and second controller 142-b operate as slave controllers, controlled by the control signals of master third controller 630. Third controller 630 can be included as a second controller as part of first heat pump unit 610 or second heat pump unit 620. In either case, the heat pump unit that includes third controller 630 is the primary heat pump unit, whereas the additional connected heat pump(s) are secondary heat pump units. For example, as illustrated in FIG. 6, third controller 630 is included in first heat pump unit 610. As such, first heat pump unit 610 is the primary heat pump of heat pump system 600, whereas second heat pump unit 620 is the secondary heat pump unit of heat pump system 600.

Third controller 630 controls both first controller 142-a and second controller 142-b in combination such that the outputs of each of first heat pump unit 610 and second heat pump unit 620 form a combined thermal output and/or air flowrate from heat pump system 600. As discussed relating to heat pump system 100 of FIG. 1 above, heat pump system 100 operates in either a cooling or heating mode where the output of the heat pump system is based upon a variety of temperature, enthalpy, pressure, and/or air quality measurements. Heat pump system 600 operates in a substantially identical fashion, where each of first heat pump unit 610 and second heat pump unit 620 are controlled to operate in either a heating or cooling mode, and the combined thermal output of both first heat pump unit 610 and second heat pump unit 620 are based upon a variety of temperature, enthalpy, pressure, and/or air quality measurements which are used to determine the thermal demand and/or air demand of an interior space of the building. For example, third controller 630 may receive a temperature measurement of refrigerant of refrigerant loop 124-a and/or 124-b, air stream 136 entering heat pump system 600 from the external environment 112, a temperature measurement of the air stream 136 taken at either one of, or any combination of, the exit of fan 130-a and/or fan 130-b, the exit duct from fans 130-a and/or fan 130-b supplying first heat exchanger 124-a and/or 124-b with air, in the air stream within first heat exchangers 124-a and/or 124-b, the exit duct of first heat exchanger 124-a and/or 124-b, and/or in internal environment 114, an enthalpy measurement of air stream 136 entering heat pump system 600 from the external environment 112, an enthalpy measurement of the airstream 136 taken at either one of, or any combination of, the exit of fans 130-a and/or fan 130-b, the exit duct from fans 130-a and/or fan 130-b supplying first heat exchanger 124-a and/or 124-b with air, in the air stream within first heat exchangers 124-a and/or 124-b, the exit duct of first heat exchangers 124-a and/or 124-b, and/or in internal environment 114, a pressure measurement of air stream 136 taken at either one, or any combination of, an exit of fans 130-a and/or 130-b, an exit duct from fans 130-a and/or 130-b supplying first heat exchangers 124-a and 124-b with air, in the air stream within first heat exchanger 124-1 and/or 124-b, and/or in an exit duct of first heat exchanger 124-a and/or 124-b, and/or an air quality measurement taken at either one location, or multiple locations, within internal environment 114.

Third controller 630 determines the overall thermal demand and/or air volume demand required to meet any of the operation/measurement scenarios described above relating to heat pump system 100 (e.g., examples one through six described relating to heat pump system 100) and determines the corresponding heating and/or cooling load required to be supplied by heat pump system 600 to meet the thermal demand. In this case, third controller 630 may send control signals to each of first controller 142-a and second controller 142-b to modulate the output of each of first heat pump unit 610 and second heat pump unit 620 to meet the thermal demand and/or air volume demand. For example, third controller 630 sends controls signals to first controller 142-a and second controller 142-b to control any of first variable speed motors 122-a and 122-b, second variable speed motors 132-a and 132-b, expansion devices 144-a and 144-b, four-way valves 146-a and 146-b, isolation valves 138-a and 138-b, three way valves 322-a and 322-b, and three way valves 422-a and 422-b to meet the thermal demand of the internal environment 114 of the building. Third controller 630 can therefore modulate (e.g., ramp) either first heat pump unit 610 and/or second heat pump unit 620 infinitely across the entire thermal operational range of heat pump system 600 (e.g., heat pump system 600 is infinitely variable/rampable across the entire combined operational range of heat pump system 600).

Third controller 630 may determine the heating, cooling, and/air flowrate demand of the internal environment 114 (e.g., as based upon various enthalpy, temperature, pressure, and/or air quality measurements as described previously), and may bring first heat pump unit 610 and second heat pump 620 into service either alone or in combination, while simultaneously varying the output of both first heat pump unit 610 and second heat pump unit 620 across the entire range of both heat pump system 610's and 620's operational capabilities to meet the various demands. In this case, the two heat pump system 610 and 620 may be regarded as “twinned”, in that the combined output of first heat pump system 610 and second heat pump system 620 can be controlled by combined logic within third controller 630, and in any combination, to meet the various operational demands.

For example, third controller 630 may determine that the thermal load and/or air flowrate required for the internal environment 114 is less than the maximum thermal capacity and/or air volume output of first heat pump unit 610. In this case, third controller 630 may bring first heat pump unit 610 online (e.g., from an idle, standby, or minimum operational condition), place first heat pump unit 610 in either a heating or cooling mode, and cause first controller 142-a to modulate at least first variable speed motor 132-a, second variable speed motor 132-a, and expansion device 144-a to meet the targeted thermal output and/or air flowrate of heat pump system 600.

In a second example, third controller 630 may determine that the thermal load and/or air flowrate required for the internal environment 114 is greater than the maximum thermal load that first heat pump unit 610 is capable of outputting, or in some cases, greater than a certain maximum percentage output value of first heat pump unit 610. In this case, third controller 630 brings both first heat pump unit 610 second heat pump unit 620 online (e.g., from an idle, standby, or minimum operational condition), places both first heat pump unit 610 and second heat pump unit 620 in either a heating or cooling mode, and modulates at least first variable speed motors 132-a and 132-b, second variable speed motors 132-a and 132-b, and expansion devices 144-a and 144-b to meet the targeted thermal output of heat pump system 600 (e.g., third controller 630 ramps the output of both first heat pump unit 610 and second heat pump unit 620). Although the previous example is described relating to bringing both first heat pump unit 610 and second heat pump unit 620 online simultaneously, it is possible to stage the order in which the heat pump units are brought online (e.g., unit 1 then unit 2, or unit 2 then unit 1) as well as the timing of which unit is brought online in relation to the other. For example, it is possible to stage a delay in time (e.g., dwell time) which first heat pump unit 610 is brought online as compared to second heat pump unit 620 and also prioritize which heat pump unit is brought online first. As such, the combined control of both heat pump units 610 and 620 through via the control logic within third controller 630 enables the flexibly staging (e.g., time/order) of twinned heat pump units.

Third controller 630 can distribute the thermal load and/or air demand across both first heat pump unit 610 and second heat pump unit 620 by any proportion that meets the required thermal load (e.g., the proportion of the thermal load that first heat pump unit 610 outputs as compared to the proportion of the thermal load that second heat pump unit 620 outputs may be evenly distributed or, in some cases, unevenly distributed between the two heat pump units 610 and 620). As such, first heat pump unit 610 and second heat pump unit 620 may operate under the same operational conditions or may operate under different operational conditions. Additionally, third controller 630 may determine that the thermal load and/or air demand required to meet the heating, cooling, or ventilation requirements of the internal environment 114 and/or air demand has dropped below the minimum operation of both first heat pump unit 610 and second heat pump unit 620 (e.g., below the minimum load of combined heat pumps system 600). In this case, third controller 630 may take one of the heat pump units offline (e.g., either turn off or place one of first heat pump unit 610 or second heat pump unit 620 in standby), and modulate the output of the online unit to meet the thermal demand (e.g., ramp up the online heat pump unit to meet the thermal demand).

Although unillustrated, air streams 136-a 136-b may flow from a common duct from the external environment 112 that branches to both first heat pump unit 610 and second heat pump unit 620. In this case, backdraft dampers may also be included either in the ducting branches connected to first heat pump unit 610 and second heat pump unit 620, or, alternatively, included as part of the air inlets on first heat pump unit 610 and second heat pump unit 620. Each backdraft damper prevents air from air stream 136-a or 136-b from flowing backwards to either heat pump unit in the event that one of the heat pump units is operational and the other heat pump unit is not (e.g., creating a pressure differential between the two units in the ducting branches). In this case, either first controller 142-a and second controller 142-b are connected to each backdraft damper respectively, and third controller 630 controls each of first controller 142-a and second controller 142-b to control the backdraft dampers, or, third controller 630 is connected to each of the dampers and controls the dampers directly. In either case, the backdraft damper that is connected to the inactive unit is closed, while the backdraft damper that is attached to the active unit remains open. As described previously, the backdraft dampers may, in some cases, be modulated backdraft dampers, which may be adjusted based upon a variety of operational conditions and supply each of first heat pump system 610 and second heat pump system 620 with a definite amount of air volume (e.g., as determined by the real airflow value of each fan 130-a and 130-b). In such cases third controller may control each of the backdraft dampers alone, or in combination, to supply each of heat pump unit 610 and second heat pump unit 620 with air.

Although unillustrated, air streams 136-a and 136-b may discharge from first heat pump unit 610 and second heat pump unit 620 to a common duct, where the combined air stream 136 flows to a distributed network of ducting throughout the internal environment 114 of the building. The distributed network of ducting may include multiple zones, where each zone may include one, or multiple, independent zone dampers. The zone dampers control the flow of air stream 136 into each zone (e.g., rooms, spaces, etc.), and may be adjusted based upon a variety of factors (e.g., automatic damper control, time, manual adjustment, etc.). In this case, first controller 142-a, second controller 142-b, and/or third controller 630 can control each of first heat pump unit 610 and second heat pump unit 620 to output a targeted temperature and enthalpy of combined air stream 136, as well as a targeted discharge pressure and/or air flowrate within the duct supplying the multiple zones with air stream 136. In this case, a pressure measurement of the combined air stream 136 (e.g., taken by a pressure sensor at some point in the combined duct) is used to determine the discharge pressure of air stream 136, and first controller 142-a, second controller 142-b, and/or third controller 630 adjusts the output pressure of either, or both of, first heat pump unit 610 and second heat pump unit 620 to meet the targeted discharge pressure. For example, in the event that a zone damper is closed (e.g., the flowrate of air stream 136 to the internal environment 114 is reduced causing for an increase in the combined duct pressure), third controller 630 may control either, or both of, second variable speed motors 132-a and/or 132-b to reduce the air flow supplied by fans 130-a and/or 130-b, thus reducing the overall air flow of air stream 136. As another example, in the event that a zone damper is opened (e.g., the flowrate of air stream 136 to the internal environment 114 is increased causing for a decrease in the measured discharge pressure), third controller 630 may control either, or both of, second variable speed motor 132-a and/or 132-b to increase the air flow supplied by fans 130-a and/or 130-b, thus increasing the overall air flow of air stream 136.

As described with reference to heat pump system 100, heat pump system 100 may be a modular heat pump system, and as described with reference to heat pump system 200, 300, 400, and 500, each of the additional features (e.g., the energy recovery ventilator of heat pump system 200, the humidity control device for heat pump system 300, the water side economizer of system 400, and or air side economizer of heat pump system 500) may be either included with, or attachable to, the components of modular heat pump system 100. Similarly, both first heat pump unit 610 and second heat pump unit 620 may be modular heat pump units (e.g., contained on a skid and/or enclosed in a housing as well as having a width size small enough to fit through a 36 inch doorway/freight elevator) which also may include, all, or some of, the additional features described with reference to heat pump system 200, 300, 400, and 500.

Modular first heat pump unit 610 and modular second heat pump unit 620 may be separate heat pump units that are both installed in the same room within a building to form a combined modular heat pump system 600. For example, modular first heat pump unit 610 and modular second heat pump unit 620 may be installed in separate construction steps (e.g., modular first heat pump unit 610 is moved into an HVAC room separately from modular second heat pump unit 620), where both heat pump units 610 and 620 combined to form one overall modular heat pump system 600. Alternatively first heat pump unit 610 may be installed in one room within a building, and second heat pump unit 620 may be installed in a separate room, whereas the fans 130-a and 130-b discharge to a combined discharge duct. In either of these cases, the ability to install each of the components separately lowers construction costs as well as increases the ease in installation, since the modular heat pump units are self-contained, and all that is required during installation is placement of the heat pump units next to one another and to connect each of the modular heat pump units to the required electrical, water, and ducting network. The modularity of the heat pump units is particularly advantageous in the retrofit of an existing HVAC system within a building. A typical HVAC system requires large single-purpose components (e.g., such as a evaporator/condenser heat exchanger that is sized to accommodate the heating/cooling load for the entire building), and many times these components need to be installed prior to the complete construction of a building, or in the case of a retrofit, disassembled and reassembled with in the HVAC space. The ability to retrofit multiple modular heat pump units solves this problem in that no disassembly is required for the modular heat pump units and the modular heat pump units can be easily installed separately in the building. Additionally, in the case that one modular heat pumps is taken offline (E.g., for maintenance, due to a component failure, etc.) other installed heat pump units can be brought online and ramped up to meet the required thermal load of the building. In this sense, even if one modular heat pump unit goes down, the entire HVAC system is not taken offline since other heat pump units are there to compensate for the offline unit, and only the maximum thermal output of the entire heat pump system is affected by the offline unit.

FIG. 7 is a system view of a heat pump system 700 in accordance with the present disclosure. Heat pump system 700 includes primary heat pump unit 710, secondary heat pump unit 720, and shared energy recovery ventilator 730. Primary heat pump unit 710 may be the same as, or substantially identical to, first heat pump unit 610 as discussed in relation to heat pump system 600 in FIG. 6, and incorporates some, or all of, the features and functionality of first heat pump unit 610. Secondary heat pump unit 720 may be the same as, or substantially identical to, second heat pump unit 620 as discussed in relation to heat pump system 600 in FIG. 6, and incorporates some, or all of, the features and functionality of second heat pump unit 620. Shared energy recovery ventilator 730 may be the same as, or substantially identical to, energy recovery ventilator 210, as discussed in relation to heat pump system 200 in FIG. 2, and incorporates the features and functionality of energy recovery ventilator 210.

Heat pump system 700 includes master controller 732. Similar to third controller 630 in heat pump system 600, master controller 732 controls both first controller 142-a and second controller 142-b as slave controllers, both in combination such that the outputs of each of primary heat pump unit 710 and secondary heat pump unit 720 form a single thermal output of heat pump system 700. Additionally, master controller 732 is included with primary heat pump unit 710, and as such, primary heat pump unit 710 is the primary heat pump unit of heat pump system 700 and secondary heat pump unit 720 is the secondary heat pump unit of heat pump system 700.

Master controller 732 also communicates with shared energy recovery ventilator controller 238. Shared energy recovery ventilator controller 238 is in communication with each of the electrical components of shared energy recovery ventilator 730 (such as the unillustrated first damper 214, second damper 216, first energy recovery fan 218, second energy recovery fan 220, first air flow sensor 222, second air flow sensor 224, first exhaust air enthalpy sensor 226, second exhaust air enthalpy sensor 228, first fresh air enthalpy sensor 230, and second fresh air enthalpy sensor 232) and controls the operation of the controllable components of shared energy recovery ventilator 730 (e.g., first damper 214, second damper 216, first energy recovery fan 218, and second energy recovery fan 220). In this case, master controller 732 receives operational data from shared energy recovery ventilator controller 238 and also sends control commands to shared energy recovery ventilator controller 238 to control the controllable components of shared energy recovery ventilator controller 238. For example, master controller 732 sends control commands to shared energy recovery ventilator controller 238 such that the air stream 136 supplying heat pump system 700 is pre-cooled or pre-warmed by the exhaust stream returned from internal environment 114, in order to increase the thermal efficiency of heat pump system 700. Master controller 732 can adjust some, or all of, the controllable components of both primary heat pump unit 710 and secondary heat pump unit 720 (e.g., at least first variable speed motors 122-a and 122-b, second variable speed motors 132-a and 132-b, and expansion devices 144-a and 144-b) such that the output of each of first primary heat pump unit 710 and secondary heat pump unit 720 meets the thermal energy demand of the interior space of the building.

As described relating to heat pump system 600, first heat pump unit 610 and second heat pump unit 620 may share a common duct whereas air flows from the external environment 112 to heat pump system 600. Similarly, primary heat pump unit 710 and secondary heat pump unit 720 may share a combined duct supplying fresh air from the external environment 112 to each heat pump unit. In this case, shared energy recovery ventilator 730 is positioned within the ducting of heat pump system 700 such that both primary heat pump unit 710 and secondary heat pump unit 720 receive air either warmed or cooled by shared energy recovery ventilator 730. Alternatively, shared energy recovery ventilator 730 may be positioned within one of the ducts supplying either primary heat pump unit 710 or secondary heat pump unit 720 rather than in the combined duct, and supply one heat pump unit with pre-warmed or pre-cooled air.

Also as described relating to heat pump system 600, first heat pump unit 610, and second heat pump unit 620 may be modular heat pump units installed separately from one another in the HVAC room of a building. Similarly, primary heat pump unit 710 and secondary heat pump unit 720 may also be modular heat pump units, and shared energy recovery ventilator 730 may be either included with one of the primary modular heat pump unit 710 or modular heat pump unit 720, or attachable to the ducting connecting the air intakes of primary modular heat pump unit 710 or modular heat pump unit 720. As such, shared energy recovery ventilator 730 also allows for ease in installation/retrofit of heat pump system 700 within a building.

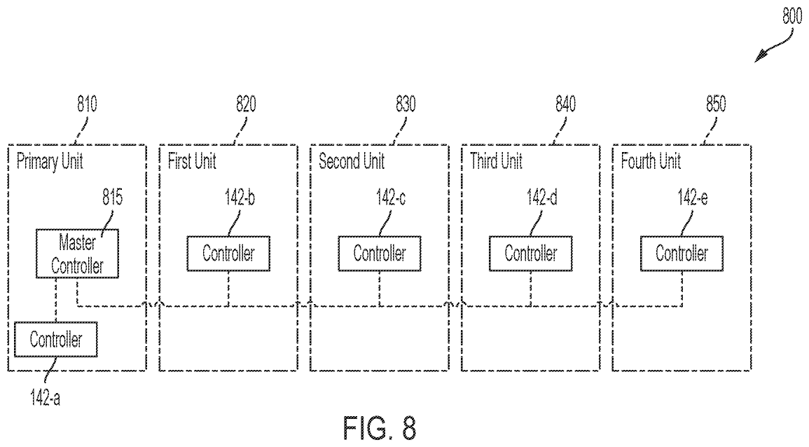

FIG. 8 is a system view of a heat pump system 800 in accordance with the present disclosure. Heat pump system 800 includes a primary heat pump unit 810, a first secondary heat pump unit 820, a second secondary heat pump unit 830, a third secondary heat pump unit 840, and a fourth secondary heat pump unit 850. Primary heat pump unit 810 may be the same as, or substantially identical to, first heat pump unit 610 as discussed in relation to heat pump system 600 in FIG. 6, and incorporates the features and functionality of first heat pump unit 610. First secondary heat pump unit 820, second secondary heat pump unit 830, third secondary heat pump unit 840, and fourth secondary heat pump unit 850, may all be the same as, or substantially identical to, second heat pump unit 620 as discussed in relation to heat pump system 600 in FIG. 6, and all incorporate the features and functionality of second heat pump unit 620.

Heat pump system 800 includes master controller 815. Similar to third controller 630 in heat pump system 600, master controller 815 controls each of first controller 142-a, second controller 142-b, third controller 142-c, fourth controller 142-d, and fifth controller 142-e as slave controllers. Additionally, master controller 815 is included with primary heat pump unit 810, and as such, primary heat pump unit 810 is the primary heat pump unit of heat pump system 800 and first secondary heat pump unit 820, second secondary heat pump unit 830, third secondary heat pump unit 840 and fourth secondary heat pump unit 850 are each secondary heat pump units of heat pump system 800.

Master controller 815 controls each of the heat pump units in combination such that the output of all of the heat pump units meets the thermal energy demand and/or air flowrate demand of the interior space of the building. For example, master controller 815 controls first controller 142-a to adjust the output of primary heat pump unit 810, second controller 142-b to adjust he output of first secondary heat pump unit 820, third controller 142-c to adjust the output of second secondary heat pump unit 830, fourth controller 142-d to adjust the output of third secondary heat pump unit 840, and fifth controller 142-e to adjust the output of fourth secondary heat pump unit 850, all in combination such the overall thermal demand of the building is met. In these cases, each of at least the variable speed motors and expansion devices of each of the heat pump units are adjusted in combination to meet the overall thermal demand of the internal environment 114 of the building (as well as any other attached controllable components). Additionally, similar to third controller 630 heat pump system 600, master controller 815 can ramp each of the heat pump units up or down, bring units on and off line, and/or distribute the proportion of the thermal demand outputted by each heat pump units either evenly or unevenly. Also as discussed relating to heat pump system 600, each of the heat pump units may discharge to a combined duct, and the pressure of the combined duct may be maintained by master controller 815 when zone dampers are adjusted in the building.

Also as described previously relating to heat pump system 600, multiple heat pump units may be “twinned”, where the operation of, and the combined thermal and/or air volume output of each of the heat pump units can be controlled by a single control logic. In the case of heat pump system 800, Master controller 815 may “twin” multiple heat pump units, and in some cases, “twin” all of the heat pump units 810, 820, 830, 840, and 850 such that the combined overall operation and thermal/air volume output of heat pump system 800 is controlled by a single control logic within master controller 815. In this case, master controller 815 can flexibly and independently stage the operation of each of the connected heat pump units, whereas traditionally, the staging of multiple connected HVAC units would have been more restricted. For example, in a traditional HVAC system, a combined control logic could be used to bring multiple HVAC units on and offline based upon fixed the numerical ordering of the HVAC units. In this case, when the thermal demand/air volume demand was exceeded by the operation of a first HVAC unit (e.g., HVAC unit 1), the control logic would bring a second HVAC unit online (e.g., HVAC unit 2). This staging ordering would carry throughout all of the connected HVAC units (e.g., unit 1, then units 1 and 2, then units 1, 2, and 3, then units 1, 2, 3, and 4, etc.). As such, the staging was directly linked to the fixed ordering of the HVAC units, and could not accommodate ordering variability, far from accommodate process variability and/or user desire to change the ordering of the next staged unit without substantial modification to the underlying control logic.

In the case of heat pump system 800, master controller 815 can bring any of the heat pump units 810, 820, 830, 840, and 850 on and offline in any order, operate each of the heat pump units either alone or in combination across the full range of thermal and/or air volume outputs of each of the heat pumps, and the staging (e.g., ordering) of the operation of each heat pump (e.g., which units are on and under what load) can be based on many different operational conditions and flexibly changed either automatically (e.g., by control logic within master control 815) or by simple user input. For example, in the case where master controller 815 brings an additional heat pump unit online, the order in which unit is brought into service may be based on a variety of conditions including true run time equalization (e.g., equalizing the true run time across all of the heat pump units total operation, rather than some heat pump units running for longer durations than others), and/or user selection of the next operational heat pump unit based upon preference (e.g., when third heat pump unit 830 is brought online due to a more advantageous operation in the building when a certain operational scenario is observed rather than second heat pump unit 820 as dictated by ordering). This allows for a substantial degree of flexibility when operating heat pump system 800, as compared to traditional HVAC systems.

It is also possible to stage the units such that a backup unit is assigned to an operational unit, and when an operational heat pump unit goes into a faulted state, the backup second heat pump unit is brought online to increase the output of heat pump system 800. The selection of the backup unit that is brought online can be based on system preference (e.g., run time equalization) and/or user preference (e.g., as based on the geography of the building). In this cases, the backup heat pump unit system may be regarded as in a reserve status based upon the operational status of the operational heat pump unit, and automatically brought online if/when the fault occurs. This type of staging can accommodate many operational scenarios and prevent the entire heat pump system 800 from faulting in the event of multiple heat pump system failures. For example, in the case where multiple heat pump units experience faults, the staging can automatically bring online multiple reserve heat pump units to meet the thermal and/or air volume demand without running the risk of a full heat pump system failure, whereas traditional systems may have become entirely locked out when multiple HVAC units become locked out. In this case, the order in which heat pump unit comes online may be based upon the backup status as described above, in that if the backup heat pump unit of heat pump unit 810 is heat pump unit 830, and the backup heat pump unit for heat pump unit 820 is heat pump unit 840, then when both heat pump unit 810 and heat pump unit 820 fault, both heat pump units 830 and 840 can be automatically brought online, rather than cause for a double faulted lock-out scenario that faults the entire heat pump system 800.

Additionally, although the above discussion is described relating to the staging and twinning of the overall operation of the heat pump units, specific components of each of the heat pump units may be twinned and/or staged by master controller 815. For example, in the case where multiple heat pump units are brought online, the fans 130s and the compressors 120s for each of the heat pump units may be twinned by master controller 815 (e.g., all of the first variable speed motors 122s and all of the second variable speed motors 133s controlled separately from one another by master controller 815) where the fans 130s are controlled separately from the compressors 120s of each of the heat pump units. In this case, the combined operation of all of the compressors 120s is based upon a targeted air set point temperature, and the combined operation of the fans 130s is based upon a duct discharge pressure. Additionally, and as described previously, each of the heat pump units may include additional features, such as fluid side economizing devices. In this case, the fluid side economizing devices may also be staged separately from the rest of the components of heat pump system 800. For example, each of the fluid side economizing devices may be staged prior to the compressors 120s.

Also as described relating to heat pump system 600, each of primary heat pump unit 810, first secondary heat pump unit 820, second secondary heat pump unit 830, third secondary heat pump unit 840, and fourth secondary heat pump unit 850 may be modular heat pump units (e.g., contained on a skid and/or enclosed in a housing as well as having a width size small enough to fit through a 36 inch doorway/freight elevator). In this case, each of the modular heat pump units are installed in an HVAC room to form a combined modular heat pump system 800. As many modular heat pump units can be installed in the HVAC room that are required to meet the overall thermal demand of the building (e.g., such as 4 modular heat pump units as illustrated in FIG. 8, as well as more/less modular heat pump units than illustrated, dependent on the thermal demand of the building), and in some case, multiple HVAC rooms that are connected by a common discharge duct. As such, a system of multiple modular heat pump units can replace a much larger single HVAC system, where the large tonnage of the single HVAC system is met by the multiple modular variable capacity heat pump units.

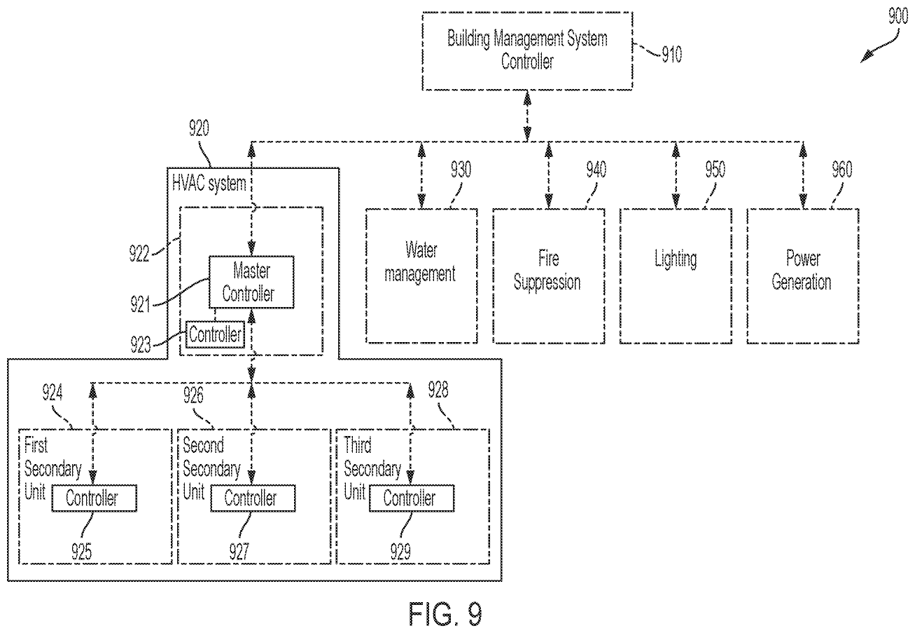

FIG. 9 is a schematic view of a building management system 900 including multiple heat pump units in accordance with the present disclosure. Building management system 900 includes building management system controller 910 which is in communication with HVAC system 920, and may additionally be in communication with other building systems such as water management system 930, fire suppression system 940, lighting system 950, power generation system 960, and/or other systems within a building. Building management system controller 910 receives operational data from, and may send control signals to, each of the connected systems of building management system 900 to control each of the separate systems included in building management system 900.

In some cases, building management system controller 910 controls each of the connected systems of building management system 900. For example, building management system controller 910, can controls each of the controllable components associated with each of water management system 930, fire suppression system 940, lighting system 950, and power generation system 960 through control signals communicated to each system.

In some cases, building management system controller 910 may also controls HVAC system 920. HVAC system 920 may include a system of multiple variable capacity heat pump units, such as primary heat pump unit 922, first secondary unit 924, second secondary unit 926 and third secondary unit 928, which may be the same as, or substantially identical to, each of primary heat pump unit 810, first secondary heat pump unit 820, second secondary heat pump unit 830, and third secondary heat pump unit 840 respectively. In a first case, building management system controller 910 communicates with master controller 921, and master controller 921 controls each of controllers 923, 925, 927, and 929 as slave controllers based upon the control commands received from building management system controller 910. For example, building management system controller 910 may send a control command to master controller 921 corresponding with an overall thermal demand required for the interior space of the building. Master controller 921 may then bring online, and modulate the output of, each of the connected heat pump units to meet the overall thermal demand. Master controller 921 may also communicate operational data regarding each of the connected heat pumps to the building management system controller 910, and the building management system controller 910 may store and process such data.

In a second case, HVAC system 920 may operate independent from building management system controller 910. As described relating to heat pump system 800, master controller 921 may independently control each of the connected heat pump units based upon the overall thermal demand of the interior space of the building. Master controller 921 can do this by bringing multiple heat pump units online and offline as well as ramping the output of such heat pump units up and down by independently controlling each of the controllable features of each heat pump based upon the various temperature and enthalpy measurements throughout the HVAC system. As such, in this case, master controller 921 may operate independent from building management system controller 910 as a standalone master controller 921, and communicate operational data to building management system controller 910 rather than be controlled by building management system controller 910.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### Aspects

Aspect 1 is a heat pump system comprising: a compressor coupled to a first variable speed motor; a first heat exchanger; a geothermal heat exchanger; a fan coupled to a second variable speed motor; an expansion device; a refrigerant loop fluidly coupling the compressor, the geothermal heat exchanger, the expansion device, and the first heat exchanger; and a first controller configured to adjust a first speed of the first variable speed motor, a second speed of the second variable speed motor, and an operation of the expansion device based upon a thermal energy demand.

Aspect 2 is a heat pump system of Aspect 1 further comprising: an energy recovery ventilator in fluid communication with an air inlet of the first heat exchanger, the energy recovery ventilator comprising: a first energy recovery fan; optionally, a second energy recovery fan; a energy exchange device operable to exchange thermal energy from an exhaust stream returned from an interior space of a building with a fresh air stream from an external environment, the fresh air stream supplying air to the air inlet of the first heat exchanger; and a second controller configured to operate the first energy recovery fan and the second energy recovery fan based upon a control signal received from the first controller.

Aspect 3 is a heat pump system of any of Aspects 1 or 2, where the energy recovery ventilator is position before the first heat exchanger in an air stream supplying the interior space of the building with air.

Aspect 4 is a heat pump system of any of Aspects 1, 2, or 3, wherein the first controller transmits the control signal to the second controller to operate the first energy recovery fan and the second energy recovery fan based upon the thermal energy demand, and wherein the first controller further adjusts the first speed of the first variable speed motor and the second speed of the second variable speed motor based upon the operation of the first energy recovery fan and the second energy recovery fan.

Aspect 5 is a heat pump system of any of Aspects 1-4 further comprising a dehumidification device, the dehumidification device including a second heat exchanger and a three way valve both fluidly coupled to the refrigerant loop, wherein the first controller is further configured to operate the three way valve based upon a humidity measurement.

Aspect 6 is a heat pump system of any of Aspects 1-5, wherein the second heat exchanger of the dehumidification device is position after the first heat exchanger in the air stream supplying the interior space of the building with air.

Aspect 7 is a heat pump system of any of Aspects 1-6, wherein the first controller is further configured to adjust the first speed of the first variable speed motor and the second speed of the second variable speed motor based upon the operation of the three way valve.

Aspect 8 is a heat pump system of any of Aspects 1-7, further comprising a working fluid side economizer device, the working fluid side economizer device including a second heat exchanger and a three way valve, the working fluid side economizer device in fluid communication with an inlet and an outlet of a working fluid side of the geothermal heat exchanger, wherein the first controller is further configured to operate the three way valve based upon a temperature of liquid supplying the working fluid side of the geothermal heat exchanger being less than a temperature of an air stream entering an air inlet of the second heat exchanger.

Aspect 9 is a heat pump system of any of Aspects 1-8, wherein the second heat exchanger of the working fluid side economizer device is position before the first heat exchanger in the air stream supplying the interior space of the building with air.

Aspect 10 is a heat pump system of any of Aspects 1-9, wherein the first controller is further configured to adjust the first speed of the first variable speed motor and the second speed of the second variable speed motor based upon the operation of the three way valve.

Aspect 11 is a heat pump system of any of Aspects 1-10, further comprising an air side economizer device, the air side economizer device including a first damper within a first duct and a second damper within a second duct, the first damper controlling a flow of an exhaust stream through the first duct returned from an interior space of a building and the second damper controlling a flow of a fresh air stream through the second duct from an external environment, and wherein the first controller is further configured to operate the first damper and the second damper based upon the thermal energy demand.

Aspect 12 is a heat pump system of any of Aspects 1-11, wherein the air side economizer device is position before the first heat exchanger in an air stream supplying the interior space of the building with air.

Aspect 13 is a heat pump system of any of Aspects 1-12, wherein the first controller is further configured to adjust the first speed of the first variable speed motor and the second speed of the second variable speed motor based upon the operation of the first damper and the second damper.

Aspect 14 is a heat pump system of any of Aspects 1-13, further comprising a dehumidification device, the dehumidification device including a second heat exchanger and a three way valve both fluidly coupled to the refrigerant loop, wherein the first controller is further configured to operate the three way valve based upon a humidity measurement of an air stream supplying the building with air as measured at an air outlet of the first heat exchanger.

Aspect 15 is a heat pump system of any of Aspects 1-14, wherein the first controller is further configured to adjust the first speed of the first variable speed motor and the second speed of the second variable speed motor based upon the operation of the three way valve.

Aspect 16 is a heat pump system of any of Aspects 1-15, further comprising a working fluid side economizer device, the working fluid side economizer device including a third heat exchanger and a second three way valve, the working fluid side economizer device in fluid communication with an inlet and an outlet of a working fluid side of the geothermal heat exchanger, wherein the first controller is further configured to operate the second three way valve based upon a temperature of working fluid supplying the working fluid side of the geothermal heat exchanger being less than a temperature of the air stream entering the air inlet of the third heat exchanger

Aspect 17 is a heat pump system of any of Aspects 1-16, wherein the first controller is further configured to adjust the first speed of the first variable speed motor and the second speed of the second variable speed motor based upon the operation of the second three way valve.

Aspect 18 is a heat pump system including, a first modular heat pump unit comprising: a first compressor coupled to a first variable speed motor; a first heat exchanger; a first geothermal heat exchanger; a first fan coupled to a second variable speed motor; and a first controller in communication with the first variable speed motor and the second variable speed motor; a second modular heat pump unit comprising: second compressor coupled to a third variable speed motor; a second heat exchanger; a second geothermal heat exchanger; a second fan coupled to a fourth variable speed motor; and a second controller in communication with the third variable speed motor and the fourth variable speed motor; and a third controller in communication with the first controller and the second controller where the third controller is a master controller, the first control and the second controller are slave controllers, and the third controller is configured to adjust a first speed of the first variable speed motor, a second speed of the second variable speed motor, a third speed of the third variable speed motor, and a fourth speed of the fourth variable speed motor based upon a thermal energy demand.

Aspect 19 is a heat pump system of Aspect 18 that includes any one of the features of the heat pump systems of Aspects 1-17.

Aspect 20 is a heat pump system of aspect 19, wherein, when the thermal energy demand exceeds a maximum thermal energy output of the first modular heat pump unit, the third controller is configured to increase the third speed of the third variable speed motor and the fourth speed of the fourth variable speed motor to generate a thermal energy output from the second modular heat pump unit to meet the thermal energy demand, and when the thermal energy demand is below a maximum thermal energy output of the first modular heat pump unit, the third controller is further configured to adjust the third speed of the third variable speed motor and the fourth speed of the fourth variable speed motor to substantially zero

Aspect 21 is system of multiple modular heat pumps, each heat pump comprising a variable speed fan, a variable speed compressor, a geothermal heat exchanger, an evaporator/condenser, and a local controller configured to control a speed of the variable speed compressor and a speed of the variable speed fan, at least one of the multiple modular heat pumps being a primary heat pump and further comprising a master controller configured to control the speed of each of the variable speed compressors and the variable speed fans based upon a thermal energy demand by control signals communicated to each of the local controller.

Aspect 22 is a system of modular heat pumps, where each heat pump may includes any of the features of the heat pump systems of Aspects 1-20.

Aspect 23 is a heat pump system of any of aspects 1-17 that includes any of the features of Aspects 18 and 19.

Aspect 24 is a heat pump system of any of aspects 1-19 or 23, or a system of modular heat pumps of any of aspects 21 and 23 wherein the heat pump systems and/or system of modular heat pumps integrate with a variable air volume system.

Aspect 25 is a heat pump system of any of aspects 1-19 or 23 and 24 or a system of modular heat pumps of any of aspects 21, 23, or 24 that is controlled by a master controller operable to control any of the features of the heat pump systems/system of modular heat pumps in any of the operational modes described previously.

What is claimed is:

1. A heat pump system, comprising:
a compressor coupled to a first variable speed motor;
a first heat exchanger;
a geothermal heat exchanger;
a fan coupled to a second variable speed motor;
an expansion device;
a refrigerant loop fluidly coupling the compressor, the geothermal heat exchanger, the expansion device, and the first heat exchanger; and
a first controller configured to adjust a first speed of the first variable speed motor, a second speed of the second variable speed motor, and an operation of the expansion device based upon a thermal energy demand.

2. The heat pump system of claim 1, further comprising:
an energy recovery ventilator in fluid communication with an air inlet of the first heat exchanger, the energy recovery ventilator comprising:
a first energy recovery fan;
optionally, a second energy recovery fan;
a energy exchange device operable to exchange thermal energy from an exhaust stream returned from an interior space of a building with a fresh air stream from an external environment, the fresh air stream supplying air to the air inlet of the first heat exchanger; and
a second controller configured to operate the first energy recovery fan and the second energy recovery fan based upon a control signal received from the first controller.

4. The heat pump system of claim 2, wherein the first controller transmits the control signal to the second controller to operate the first energy recovery fan and the second energy recovery fan based upon the thermal energy demand, and wherein the first controller further adjusts the first speed of the first variable speed motor and the second speed of the second variable speed motor based upon the operation of the first energy recovery fan and the second energy recovery fan.

5. The heat pump system of claim 1, further comprising a dehumidification device, the dehumidification device including a second heat exchanger and a three way valve both fluidly coupled to the refrigerant loop, wherein the first controller is further configured to operate the three way valve based upon a humidity measurement.

6. The heat pump system of claim 5, wherein the second heat exchanger of the dehumidification device is position after the first heat exchanger in the air stream supplying the interior space of the building with air.

7. The heat pump system of claim 5, wherein the first controller is further configured to adjust the first speed of the first variable speed motor and the second speed of the second variable speed motor based upon the operation of the three way valve.

8. The heat pump system of claim 1, further comprising a working fluid side economizer device, the working fluid side economizer device including a second heat exchanger and a three way valve, the working fluid side economizer device in fluid communication with an inlet and an outlet of a working fluid side of the geothermal heat exchanger, wherein the first controller is further configured to operate the three way valve based upon a temperature of liquid supplying the working fluid side of the geothermal heat exchanger being less than a temperature of an air stream entering an air inlet of the second heat exchanger.

9. The heat pump system of claim 8, wherein the second heat exchanger of the working fluid side economizer device is position before the first heat exchanger in the air stream supplying the interior space of the building with air.

10. The heat pump system of claim 8, wherein the first controller is further configured to adjust the first speed of the first variable speed motor and the second speed of the second variable speed motor based upon the operation of the three way valve.

11. The heat pump system of claim 1, further comprising an air side economizer device, the air side economizer device including a first damper within a first duct and a second damper within a second duct, the first damper controlling a flow of an exhaust stream through the first duct returned from an interior space of a building and the second damper controlling a flow of a fresh air stream through the second duct from an external environment, and wherein the first controller is further configured to operate the first damper and the second damper based upon the thermal energy demand.

12. The heat pump system of claim 11, wherein the air side economizer device is position before the first heat exchanger in an air stream supplying the interior space of the building with air.

13. The heat pump system of claim 11, wherein the first controller is further configured to adjust the first speed of the first variable speed motor and the second speed of the second variable speed motor based upon the operation of the first damper and the second damper.

14. The heat pump system of claim 4, further comprising a dehumidification device, the dehumidification device including a second heat exchanger and a three way valve both fluidly coupled to the refrigerant loop, wherein the first controller is further configured to operate the three way valve based upon a humidity measurement of an air stream supplying the building with air as measured at an air outlet of the first heat exchanger.

15. The heat pump system of claim 14, wherein the first controller is further configured to adjust the first speed of the first variable speed motor and the second speed of the second variable speed motor based upon the operation of the three way valve.

16. The heat pump system of claim 15, further comprising a working fluid side economizer device, the working fluid side economizer device including a third heat exchanger and a second three way valve, the working fluid side economizer device in fluid communication with an inlet and an outlet of a working fluid side of the geothermal heat exchanger, wherein the first controller is further configured to operate the second three way valve based upon a temperature of working fluid supplying the working fluid side of the geothermal heat exchanger being less than a temperature of the air stream entering the air inlet of the third heat exchanger.

17. The heat pump system of claim 16, wherein the first controller is further configured to adjust the first speed of the first variable speed motor and the second speed of the second variable speed motor based upon the operation of the second three way valve.

18. A heat pump system, comprising:
a first modular heat pump unit comprising:
a first compressor coupled to a first variable speed motor;
a first heat exchanger;
a first geothermal heat exchanger;
a first fan coupled to a second variable speed motor; and
a first controller in communication with the first variable speed motor and the second variable speed motor;
a second modular heat pump unit comprising:
a second compressor coupled to a third variable speed motor;
a second heat exchanger;
a second geothermal heat exchanger;
a second fan coupled to a fourth variable speed motor; and
a second controller in communication with the third variable speed motor and the fourth variable speed motor; and
a third controller in communication with the first controller and the second controller where the third controller is a master controller, the first control and the second controller are slave controllers, and the third controller is configured to adjust a first speed of the first variable speed motor, a second speed of the second variable speed motor, a third speed of the third variable speed motor, and a fourth speed of the fourth variable speed motor based upon a thermal energy demand.

19. The heat pump system of claim 18, wherein, when the thermal energy demand exceeds a maximum thermal energy output of the first modular heat pump unit, the third controller is configured to increase the third speed of the third variable speed motor and the fourth speed of the fourth variable speed motor to generate a thermal energy output from the second modular heat pump unit to meet the thermal energy demand, and when the thermal energy demand is below a maximum thermal energy output of the first modular heat pump unit, the third controller is further configured to adjust the third speed of the third variable speed motor and the fourth speed of the fourth variable speed motor to substantially zero.

20. A system of multiple modular heat pumps, each heat pump comprising a variable speed fan, a variable speed compressor, a geothermal heat exchanger, an evaporator/condenser, and a local controller configured to control a speed of the variable speed compressor and a speed of the variable speed fan, at least one of the multiple modular heat pumps being a primary heat pump and further comprising a master controller configured to control the speed of each of the variable speed compressors and the variable speed fans based upon a thermal energy demand by control signals communicated to each of the local controller.
